(19) United States
(12) Patent Application Publication
(10) Pub. No.: US 2021/0238758 A1
(43) Pub. Date: Aug. 5, 2021

(54) PHOTOCATALYST ELECTRODE AND METHOD FOR PRODUCING PHOTOCATALYST ELECTRODE

(71) Applicants: NATIONAL UNIVERSITY CORPORATION KOBE UNIVERSITY, Hyogo (JP); KANEKA CORPORATION, Osaka (JP)

(72) Inventors: Takashi Tachikawa, Hyogo (JP); Tomokazu Tozawa, Osaka (JP)

(73) Assignees: NATIONAL UNIVERSITY CORPORATION KOBE UNIVERSITY, Hyogo (JP); KANEKA CORPORATION, Osaka (JP)

(21) Appl. No.: 17/053,500

(22) PCT Filed: Apr. 26, 2019
(86) PCT No.: PCT/JP2019/018064

§ 371 Date: Nov. 6, 2020

(30) Foreign Application Priority Data
May 7, 2018 (JP) 2018-089446
Aug. 24, 2018 (JP) 2018-157598

(51) Int. Cl. C25B 11/087; C25B 1/55; B01J 35/00; B01J 23/745; B01J 35/08; B01J 37/08; B01J 35/02; B01J 37/02; B01J 21/06

(52) U.S. Cl. CPC C25B 11/087; C25B 1/55; B01J 35/004; B01J 23/745; B01J 21/063; B01J 37/08; B01J 35/023; B01J 37/0215; B01J 35/08

(57) ABSTRACT

The present invention is to provide a photocatalyst electrode less likely to suffer from peeling of hematite-based crystal particles from a substrate and having higher catalytic activity than ever before. A method for producing a photocatalyst electrode includes: an in-process particle of heating a raw material solution to form in-process particles, the raw material solution including a raw material solvent and a hematite raw material dispersed therein, the in-process particle forming step including heating the raw material solution in a closed vessel for more than 12 hours; and a burning step of burning the in-process particles. In this way, a photocatalyst electrode with high catalytic activity can be produced.

### TECHNICAL FIELD

The present invention relates to a photocatalyst electrode in which hematite-based crystal particles are stacked, and a method for producing the photocatalyst electrode.

### BACKGROUND ART

Recently, for production of a hydrogen gas fuel, a photocatalyst electrode for producing a hydrogen gas fuel by electrolyzing water with the aid of solar light has been developed.

For the photocatalyst electrode, for example, a hematite catalyst is used. The hematite catalyst has a wider absorption wavelength range, absorbs visible light, and has higher theoretical limit efficiency as compared to other photocatalysts such as tungsten oxide (WO₃) and bismuth vanadate (BiVO₄), and therefore has been extensively studied.

Documents related to the present invention include Patent Documents 1 and 2.

### PRIOR ART DOCUMENTS

### Patent Documents

Patent Document 1: JP 2004-504934 A

Patent Document 2: WO 2013/115213 A

### DISCLOSURE OF INVENTION

### Technical Problem

Conventional studies on hematite catalysts are intended to improve catalytic activity by controlling the crystal structures of individual particles to improve the charge separation efficiency of the particles themselves which form a hematite catalyst.

However, in the structures of conventional hematite catalysts, mismatch of particle interfaces occurs between hematite particles, so that particle boundary resistance increases. Thus, with conventional hematite catalysts, sufficient catalytic activity cannot be obtained because even when electrons are separated from holes by irradiation with light, the separated electrons recombine with the holes in hematite particles before moving between the hematite particles to reach a conductive substrate.

In addition, conventional hematite catalysts have the problem that charge separation efficiency can be improved in individual particles, but when the hematite catalyst is actually laminated on a conductive substrate as a photocatalyst electrode, the bonding strength between the conductive substrate and the hematite catalyst is not sufficient, and thus the hematite catalyst is peeled from the conductive substrate after the photocurrent density is measured.

Thus, an object of the present invention is to provide a photocatalyst electrode less likely to suffer from peeling of hematite-based crystal particles from a substrate and having higher catalytic activity than ever before, and a method for producing the photocatalyst electrode.

### Solution to Problem

For solving the above-described problems, the present inventors have extensively conducted studies on a hematite-based photocatalyst in terms of peeling from a substrate and catalytic activity. As a result, it was found that by performing heating for a predetermined time with use of a solvothermal method to form in-process particles of good quality, and burning the in-process particles, hematite-based crystal particles can be produced which are less likely to peel from a substrate and has higher catalytic activity than ever before.

One aspect of the present invention, which is derived on the basis of the above-mentioned finding, is a method for producing a photocatalyst electrode, the photocatalyst electrode including: a substrate; and a plurality of hematite-based crystal particles stacked on a first main surface of the substrate, the method comprising: an in-process particle forming step of heating a raw material solution to form in-process particles, the raw material solution including a raw material solvent and a hematite raw material dispersed therein, the in-process particle forming step including heating the raw material solution in a closed vessel for more than 12 hours at a temperature equal to or higher than a boiling point of the raw material solvent; and a burning step of burning the in-process particles.

The “hematite-based crystal particles” as used herein are crystal particles having a hematite (α-Fe₂O₃) crystal structure as a basic skeleton, and include not only hematite but also hematite doped with a metal other than Fe.

The “in-process particles” as used herein are particles generated during production of the final product, and include particles of a precursor and particles before burning for annealing etc.

A preferred aspect is that the method further including a coating step that includes: dispersing the in-process particles in a dispersion solvent to form a dispersion solution; and coating the substrate with the dispersion solution, wherein the burning step includes burning the in-process particles with which the substrate is coated in the coating step.

According to this aspect, in-process particles are separately formed in a closed vessel in advance, and the formed hematite-based crystal particles are sintered on a substrate as a separate body, so that the synthesis procedure is simple, and industrial mass production is possible.

A preferred aspect is that the in-process particle forming step includes: introducing the raw material solution into the closed vessel; and heating the substrate in the closed vessel in a state that the substrate is partially or totally immersed in the raw material solution, and wherein the burning step includes: taking out the substrate from the raw material solution; and burning the substrate outside the closed vessel.

According to this aspect, the substrate is immersed in the raw material solution, and heating is performed to carry out reaction in a closed state, so that the heating can be performed with the in-process particles regularly stacked on the substrate, and the hematite-based crystal particles can be stacked in a state of being regularly arranged.

A preferred aspect is that the hematite raw material includes a titanium-containing compound.

The “titanium-containing compound” as used herein refers to a compound containing titanium in the chemical formula of the compound, for example a titanium-containing halide, a titanium-containing nitric acid compound, a titanium-containing sulfuric acid compound, a titanium-containing alkoxide, a titanium-containing complex compound or the like.

A preferred aspect is that the raw material solvent is alcohol.

A preferred aspect is that the raw material solvent is water.

One aspect of the present invention is a photocatalyst electrode including: a substrate; and a plurality of hematite-based crystal particles stacked on a first main surface of the substrate, wherein the plurality of hematite-based crystal particles have a spherical shape or a shape with rounded corners and form a hematite layer covering the first main surface of the substrate, wherein the plurality of hematite-based crystal particles include a first and a second hematite-based crystal particles, the first and the second hematite-based crystal particles adjacently located, and wherein a part of an outer surface of the first hematite-based crystal particle is fixed to an outer surface of the second hematite-based crystal particle.

The “shape with rounded corners” as used herein is a shape in which corners are rounded to form a curved surface. That is, the “shape with rounded corners” is not angular, and does not have sharp corners.

According to this aspect, the first main surface of the substrate is covered with the hematite-based crystal particles in a layered form, so that catalytic activity per unit area can be improved.

According to this aspect, the outer surfaces of the adjacent first hematite-based crystal particle and second hematite-based crystal particle are fixed together, and therefore a good binding property is obtained, so that grain boundary resistance can be made smaller than ever before.

Thus, according to this aspect, for example, a photocatalyst is obtained which exhibits higher activity than ever before at the time when the catalyst is exposed to water and irradiated with light to decompose water.

A preferred aspect is that the first hematite-based crystal particle and the second hematite-based crystal particle are fixed to each other in a direction intersecting a direction orthogonal to the first main surface.

A preferred aspect is that the plurality of hematite-based crystal particles include a third hematite-based crystal particle adjacent to the first hematite-based crystal particle, and the outer surface of the first hematite-based crystal particle is fixed to a part of an outer surface of the third hematite-based crystal particle at a part different from the part where the first hematite-based crystal particle is fixed to the second hematite-based crystal particle.

A more preferred aspect is that the first hematite-based crystal particle has a cavity inside the particle.

A more preferred aspect is that the first hematite-based crystal particle has two or more cavities inside the particle.

A more preferred aspect is that the cavity communicates outside.

A preferred aspect is that in the hematite layer, four or more cavities provided in the hematite-based crystal particles exist in an area of 500 nm square on a cross-section orthogonal to the first main surface of the substrate.

A preferred aspect is that the hematite layer has a gap extending from the outer surface toward the substrate through spaces between the hematite-based crystal particles.

A preferred aspect is that the plurality of hematite-based crystal particles constitute a crystal aggregation, and the crystal aggregation has a hole formed at an interface between adjacent hematite-based crystal particles.

A preferred aspect is that the hematite-based crystal particles are doped with titanium.

A preferred aspect is that the hematite layer has an average thickness of 1 μm or more.

Preferred aspect is that there is a difference between a number average particle diameter of the hematite-based crystal particles observed with a scanning electron microscope and a crystallite diameter calculated from the Scherrer formula on the basis of half width of a diffraction peak in X-ray diffraction measurement, and a ratio of the number average particle diameter of the hematite-based crystal particles to the crystallite diameter is 3 or more and 20 or less.

A preferred aspect is that the substrate is a transparent conductive substrate having a transparent conductive layer laminated on a transparent substrate, the transparent conductive layer has irregularities on a surface thereof, and the plurality of hematite-based crystal particles include a hematite-based crystal particle that has a particle diameter smaller than a depth of a recessed section of the transparent conductive layer and that is fixed to the transparent conductive layer in the recessed section.

A preferred aspect is that when the photocatalyst electrode is immersed in water together with a counter electrode, the water is oxidized with irradiation of light.

One aspect of the present invention is a photocatalyst electrode including: a substrate; and a plurality of hematite-based crystal particles stacked on a first main surface of the substrate, wherein the plurality of hematite-based crystal particles form a hematite layer covering the first main surface of the substrate, wherein the hematite-based crystal particles each include a plurality of crystalline particles aggregated therein and fixing together in a planar shape, wherein there is a difference between a number average particle diameter of the hematite-based crystal particles observed with a scanning electron microscope and a crystallite diameter calculated from the Scherrer formula on the basis of half width of a diffraction peak in X-ray diffraction measurement, wherein a number average particle diameter of the hematite-based crystal particles is 200 nm or less, and wherein the crystallite diameter is 25 nm or less.

### Effect of Invention

The method for producing a photocatalyst electrode according to the present invention enables production of a photocatalyst electrode which is less likely to peel from a substrate and has higher catalytic activity than ever before.

The photocatalyst electrode of the present invention is less likely to peel from a substrate and has higher catalytic activity than ever before.

### BRIEF DESCRIPTION OF DRAWINGS

FIG. 1 is a cross-sectional view schematically showing a photocatalyst electrode according to a first embodiment of the present invention.

FIGS. 2A and 2B show explanatory views of hematite-based crystal particles of FIG. 1, where FIG. 2A is a perspective view of a part of a hematite layer, and FIG. 2B is a sectional perspective view of a hematite-based crystal particle.

FIGS. 3A and 3B show explanatory views of a photocatalyst electrode according to a second embodiment of the present invention, where FIG. 3A is a side view, and FIG. 3B is a perspective view of a hematite layer.

FIG. 4 is a cross-sectional view schematically showing a photocatalyst electrode according to a third embodiment of the present invention.

FIGS. 5A and 5B show explanatory views of hematite-based crystal particles of FIG. 4, where FIG. 5A is a perspective view of a part of a hematite layer, and FIG. 5B is a sectional perspective view of a hematite-based crystal particle.

FIG. 6 is a perspective view schematically showing a part of a photocatalyst electrode according to a fourth embodiment of the present invention.

FIG. 7 is a perspective view schematically showing a part of a photocatalyst electrode according to a fifth embodiment of the present invention.

FIG. 8 is a perspective view schematically showing a part of a photocatalyst electrode according to a sixth embodiment of the present invention.

FIG. 9 shows X-ray diffraction charts obtained by powder X-ray diffraction measurement of photocatalytic electrodes of Experimental Examples 1-1 and 2, and Comparative Example 1, each chart being respectively normalized with a peak of the Miller index (102) plane, wherein chart (a) represents Experimental Example 1-1, chart (b) represents Experimental Example 2, and chart (c) represents Comparative Example 1.

FIG. 10 shows X-ray diffraction charts obtained by powder X-ray diffraction measurement of photocatalytic electrodes of Experimental Examples 3 and 4, wherein chart (a) represents Experimental Example 3 and chart (b) represents Experimental Example 4.

FIG. 11 shows X-ray diffraction charts obtained by powder X-ray diffraction measurement of the photocatalyst electrodes of Experimental Examples 5 and 6, and Comparative Examples 2 and 3, wherein chart (a) represents Experimental Example 5, chart (b) represents Comparative Example 2, chart (c) represents Experimental Example 6, and chart (d) represents Comparative Example 3.

FIG. 12 shows a scanning electron microscope image of a cross-section of the photocatalyst electrode of Experimental Example 1-1, which is magnified 15,000 times.

FIGS. 13A and 13B show a scanning electron microscope image of a cut surface of the photocatalyst electrode of Experimental Example 1-2, which is cut with a broad ion beam (BIB), wherein FIG. 13A shows an image of the cut surface of Example 1-2, which is magnified 15,000 times, and FIG. 13B is a sketch of the image of FIG. 13A.

FIGS. 14A and 14B shows a scanning electron microscope image of a cut surface of the photocatalyst electrode of Experimental Example 3, which is cut with a broad ion beam (BIB), wherein FIG. 14A shows an image of the cut surface of Example 3 which is magnified 15,000 times, and FIG. 14B is a sketch of the image of FIG. 14A.

FIGS. 15A and 15B show a scanning electron microscope image of the photocatalyst electrode of Experimental Examples 1-2 and 2, wherein FIG. 15A shows an image of the photocatalyst electrode of Experimental Example 1-2, which is magnified 20,000 times, and FIG. 15B shows an image of the photocatalyst electrode of Experimental Example 2, which is magnified 20,000 times.

FIGS. 16A and 16B show a scanning electron microscope image of hematite-based crystal particles used for the photocatalyst electrode of Experimental Example 1-2, wherein FIG. 16A shows an image of the particles magnified 100,000 times, and FIG. 16B is a sketch of the image of FIG. 16A.

FIGS. 17A and 17B show a scanning electron microscope image of hematite-based crystal particles used in the photocatalyst electrode of Experimental Example 2, wherein FIG. 17A shows an image of the particles magnified 100,000 times, and FIG. 17B is a sketch of the image of FIG. 17A.

FIG. 18 shows a scanning electron microscope image of hematite-based crystal particles used in the photocatalyst electrode of Comparative Example 1, which is magnified 22,000 times.

FIGS. 19A and 19B show a scanning electron microscope image of hematite-based crystal particles used for the photocatalyst electrode of Experimental Example 3, wherein FIG. 19A shows an image of the particles magnified 50,000 times, and FIG. 19B is a sketch of the image of FIG. 19A.

FIGS. 20A and 20B show a scanning electron microscope image of hematite-based crystal particles used for the photocatalyst electrode of Experimental Example 3, wherein FIG. 20A shows an image of the particles magnified 100,000 times, and FIG. 20B is a sketch of the image of FIG. 20A.

FIGS. 21A and 21B show a scanning electron microscope image of hematite-based crystal particles used for the photocatalyst electrode of Experimental Example 4, wherein FIG. 21A shows an image of the particles magnified 50,000 times, and FIG. 21B is a sketch of the image of FIG. 21A.

FIGS. 22A and 22B show a scanning electron microscope image of hematite-based crystal particles used for the photocatalyst electrode of Experimental Example 4, wherein FIG. 22A shows an image of the particles magnified 100,000 times, and FIG. 22B is a sketch of the image of FIG. 22A.

FIGS. 23A, 23B, 23C, and 23D show a scanning electron microscope image of the photocatalyst electrode of Experimental Example 5, wherein FIG. 23A is an image of the photocatalyst electrode magnified 2,000 times, FIG. 23B is an image of the photocatalyst electrode magnified 18,000 times, FIG. 23C is an image of the photocatalyst electrode magnified 15,000 times, and FIG. 23D is an image of the photocatalyst electrode magnified 10,000 times.

FIGS. 24A and 24B show a scanning electron microscope image of hematite-based crystal particles used for the photocatalyst electrode of Experimental Example 5, wherein FIG. 24A shows an image of the particles magnified 100,000 times, and FIG. 24B is a sketch of the image of FIG. 24A.

FIGS. 25A and 25B show a scanning electron microscope image of the photocatalyst electrode of Experimental Example 6, wherein FIG. 25A shows an image of the photocatalyst electrode magnified 600 times, and FIG. 25B shows an image of the photocatalyst electrode magnified 16,000 times.

FIGS. 26A and 26B show a scanning electron microscope image of hematite-based crystal particles used for the photocatalyst electrode of Experimental Example 6, wherein FIG. 26A shows an image of the particles magnified 100,000 times, and FIG. 26B is a sketch of the image of FIG. 26A.

FIGS. 27A and 27B shows scanning electron microscope images of hematite-based crystal particles used for the photocatalyst electrode of Comparative Example 3, where FIG. 27A shows an image of the particles magnified 15,000 times, and FIG. 27B shows an image of the particles magnified 50,000 times.

FIGS. 28A and 28B show a transmission electron microscope image and selected area electron diffraction image of the surface of a hematite-based crystal particle before and after burning in Experimental Example 1-1, wherein FIG. 28A shows an image of the hematite-based crystal particles before burning, and FIG. 28B shows an image of the hematite-based crystal particles after burning.

FIGS. 29A and 29B show an image of the surfaces of hematite-based crystal particles in Experimental Example 1-1 before and after burning, which are observed with a transmission electron microscope, and subjected to elemental mapping with energy dispersive X-ray spectrometry, wherein FIG. 29A shows an image of the hematite-based crystal particles before burning, and FIG. 29B shows an image of the hematite-based crystal particles after burning.

FIG. 30 shows Nyquist plots of the photocatalyst electrodes of Experimental Examples 1-1 and 2, and Comparative Example 1.

FIG. 31 shows an equivalent circuit used for fitting the Nyquist plots of FIG. 30.

FIG. 32 shows Mott-Schottky plots of the photocatalyst electrodes of Experimental Examples 1-1 and 2, and Comparative Example 1.

FIG. 33 shows graphs representing a photocurrent density with respect to the potential of the photocatalyst electrode of Experimental Examples 1-1 and 2 and Comparative Example 1.

FIG. 34 shows graphs representing a photocurrent density with respect to the potential of the photocatalyst electrodes of Experimental Examples 3, 4, and 8 and Comparative Example 1.

FIG. 35 shows graphs representing a photocurrent density with respect to the potential of the photocatalyst electrodes of Experimental Examples 5 and 6 and Comparative Examples 2 and 3.

FIG. 36 shows graphs representing a photocurrent density with respect to the potential of the photocatalyst electrodes of Experimental Examples 1-2, 2 and 7 and Comparative Example 1.

### BEST MODE FOR CARRYING OUT THE INVENTION

Hereinafter, embodiments of the present invention will be described in detail. Unless otherwise specified, physical properties are based on the standard conditions of 25° C. and 1 atm.

A photocatalyst electrode 1 of a first embodiment of the present invention is a water photolyzing photocatalyst electrode mainly used for decomposition of water, and forms an electrode of a water photolysis cell.

The photocatalyst electrode 1 forms an anode electrode which oxidizes water to form oxygen when immersed in water as decomposition target together with a cathode electrode as a counter electrode, and irradiated with light. That is, the photocatalyst electrode 1 exhibits catalytic activity when irradiated with light, and does not exhibit catalytic activity when the photocatalyst electrode 1 is not irradiated with light.

The photocatalyst electrode 1 and the cathode electrode are connected to an auxiliary power source such as a solar cell outside the water photolysis cell, and by irradiating the photocatalyst electrode 1 and the solar cell with light, water is reduced at the cathode electrode to form hydrogen.

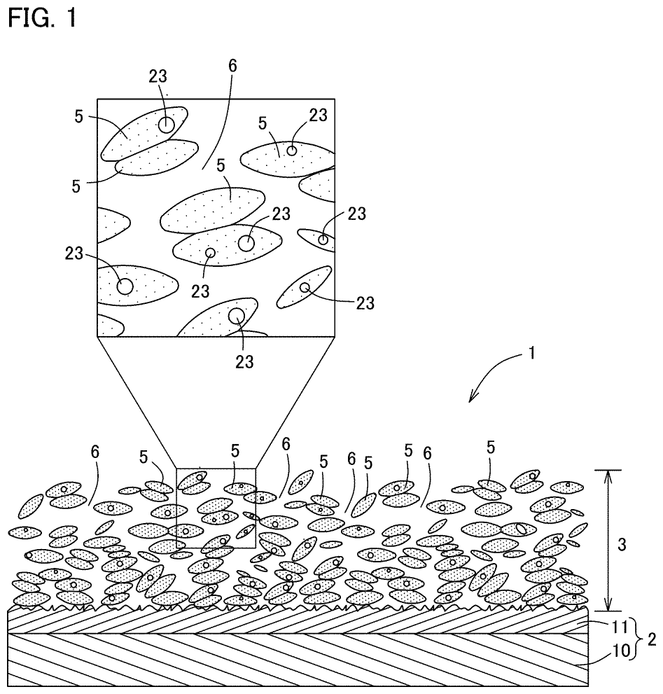

As shown in FIG. 1, the photocatalyst electrode 1 has a hematite layer 3 composed of hematite-based crystal particles 5 regularly oriented on a first main surface of a substrate 2. The photocatalyst electrode 1 of this embodiment has one of main features in the structure of the hematite-based crystal particles 5.

On the basis of the foregoing, the configuration of each portion of the photocatalyst electrode 1 will be described in detail below.

(Substrate 2)

The substrate 2 is a transparent conductive substrate which has conductivity and is capable of transmitting light, and the substrate is a plate-shaped substrate extending in a planar shape. The substrate 2 is a supporting substrate that supports the hematite-based crystal particles 5 after sintering.

The substrate 2 of the this embodiment is a transparent conductive substrate in which a transparent conductive layer 11 is laminated on a transparent substrate 10 as shown in FIG. 1, the first main surface is composed of the transparent conductive layer 11, and the second main surface is composed of the transparent substrate 10.

The transparent substrate 10 is not particularly limited as long as it has transparency. As the transparent substrate 10, for example, a transparent insulating substrate such as a glass substrate can be used.

The transparent conductive layer 11 is not particularly limited as long as it is a transparent conductive layer having transparency and conductivity. The transparent conductive layer 11 can be, for example, a transparent conductive oxide layer formed of a transparent conductive oxide such as indium tin oxide (ITO), fluorine-doped tin oxide (FTO) or zinc oxide (ZnO).

(Hematite Layer 3)

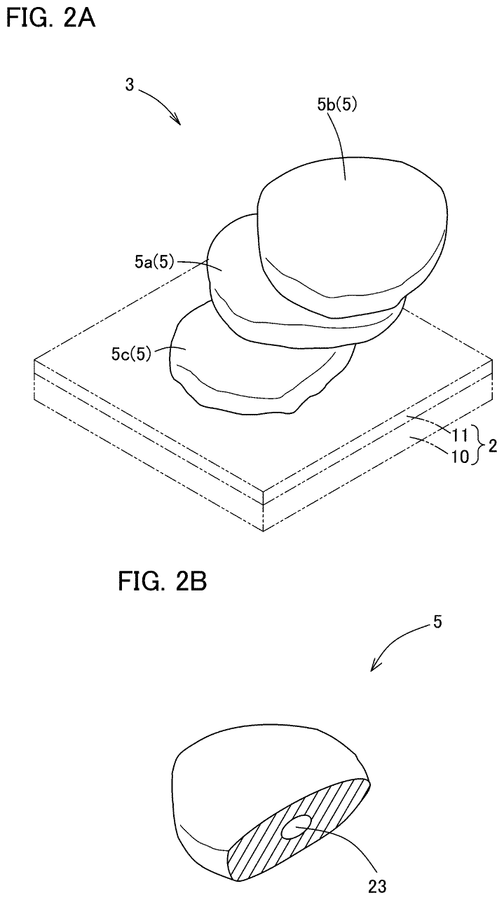

The hematite layer 3 is a photocatalyst layer formed by gathering of a large number of hematite-based crystal particles 5, where the hematite-based crystal particles 5 are three-dimensionally and regularly arranged with the substrate 2 as an origin. That is, the hematite layer 3 is a layer in which as shown in FIG. 2, the hematite-based crystal particles 5 are three-dimensionally stacked, and the hematite-based crystal particles 5 are partially fixed together to form a three-dimensional structure.

As shown in FIG. 1, the hematite layer 3 has a plurality of gaps 6 formed between the hematite-based crystal particles 5 in the extending direction of the substrate 2, and the gaps 6 extend from the outer surface of the hematite layer 3 toward the first main surface of the substrate 2. That is, when the hematite layer 3 is immersed in water, water can enter through the gaps 6 and come into contact with the hematite-based crystal particles 5 forming the inner walls of the gaps 6.

The average thickness of the hematite layer 3 is preferably 1.0 μm or more and 2.0 μm or less.

When the average thickness is within the above-mentioned range, the hematite-based crystal particles 5 are easily exposed to water in decomposition of water, so that high catalytic activity can be exhibited.

(Hematite-Based Crystal Particles 5)

The hematite-based crystal particles 5 are formed by aggregation and growth of a plurality of crystalline nanoparticles (crystalline particles), and composed of regularly oriented crystalline nanoparticles. Specifically, the hematite-based crystal particles 5 are formed by fixing crystalline nanoparticles together in a planar shape, and have a mesocrystal having a corundum crystal structure.

The “mesocrystal” as used herein is a crystalline nanoparticle aggregate in which crystalline nanoparticles are densely and regularly integrated.

The hematite-based crystal particles 5 according to this embodiment have crystalline nanoparticles oriented mainly along the (104) plane.

The hematite-based crystal particles 5 according to this embodiment have hematite doped with titanium.

The doping amount of titanium in the hematite-based crystal particle 5 at the time of performing energy dispersive X-ray spectrometry (EDX) of one hematite-based crystal particle 5 is preferably more than 0% and not more than 10%.

As shown in FIG. 2, the hematite-based crystal particle 5 has a flat outer shape and a substantially oval or elliptical cross-sectional shape.

The hematite-based crystal particle 5 is plate-shaped, and has a substantially circular shape, a substantially elliptical shape or a substantially oval shape in plan view, with the vertical and horizontal sizes each being larger than the thickness. That is, in the hematite-based crystal particle 5, the length of the minor axis (the shortest distance in the vertical and horizontal directions) is larger than the thickness.

In the hematite-based crystal particle 5, the length of the minor axis is preferably not less than 2 times, more preferably not less than 2.5 times the thickness.

The “substantially circular shape, substantially elliptical shape or substantially oval shape” as used herein means a generally circular shape, a generally elliptical shape or a generally oval shape as a whole, and includes tetra-or-higher polygonal shapes having rounded corners. Specifically, the “substantially circular shape, substantially elliptical shape or substantially oval shape” is a shape which can be regarded as a circular shape, an elliptical shape or an oval shape when observed at a low magnification (for example, 10,000 times).

As shown in FIG. 2, the hematite-based crystal particles 5 are stacked in a thickness direction (a direction orthogonal to the main surface of the substrate 2) to form a stepped shape, and at least a part of one surface is fixed to another hematite-based crystal particle 5 adjacent in the thickness direction, in a planar shape. That is, the hematite-based crystal particles 5 have an overlapping part with other hematite-based crystal particles 5 when viewed in the thickness direction (direction orthogonal to the main surface of the substrate 2).

In other words, the hematite-based crystal particles 5 overlap with other hematite-based crystal particles 5 in a direction orthogonal to the main surface of the substrate 2.

The hematite-based crystal particles 5 according to this embodiment include a hematite-based crystal particle 5a (first hematite-based crystal particles) sandwiched between other hematite-based crystal particles 5b and 5c (second hematite-based crystal particle and third hematite-based crystal particle) adjacent in the thickness direction as shown in FIG. 2, and both surfaces of the hematite-based crystal particle 5a are partially fixed to other hematite-based crystal particles 5b and 5c, respectively, in a planar shape.

The hematite-based crystal particles 5 according to this embodiment include particles that are partially fixed to other hematite-based crystal particles 5 in the extending direction of the substrate 2 as shown in FIG. 1. That is, the hematite-based crystal particles 5 are formed in such a manner as to grow not only in the thickness direction from the substrate 2 but also in the extending direction of the substrate 2.

The overlapping area of the hematite-based crystal particle 5 with another hematite-based crystal particle 5 adjacent in the thickness direction is preferably 10% or more and 50% or less of its total area when the hematite-based crystal particle 5 is viewed in the thickness direction (direction perpendicular to the substrate 2).

When the overlapping area is within the above-mentioned range, a sufficient contact area between the hematite-based crystal particles 5 can be secured, and the charge transfer resistance in the hematite layer 3, particularly the particle boundary resistance between the hematite-based crystal particles 5 can be reduced.

The number average particle diameter of the hematite-based crystal particles 5 observed with a scanning electron microscope (SEM) is preferably 100 nm or more, and more preferably 200 nm or more. The number average particle diameter of the hematite-based crystal particles 5 is preferably 500 nm or less, more preferably 300 nm or less.

When the number average particle diameter is within the above-mentioned range, high catalytic activity can be maintained while deterioration during the reaction is suppressed.

The “number average particle diameter” as used herein is a particle diameter obtained by extracting 20 hematite-based crystal particles 5 observed with SEM, and determining an average of the 20 particles.

The crystallite diameter of the hematite-based crystal particles 5, which is determined by X-ray diffraction (XRD) measurement and calculation from the Scherrer formula (1) below, is preferably 25 nm or more and 35 nm or less.

It is preferable that in the hematite-based crystal particles 5, there is a difference between the number average particle diameter observed with SEM and the crystallite diameter determined by XRD measurement.

In the hematite-based crystal particles 5, the ratio of the number average particle diameter to the crystallite diameter is preferably 5 or more. In the hematite-based crystal particle 5, the above-mentioned ratio is preferably 10 or less.

Crystallite diameter (Å)=K·λ/(β cos θ) (1)

K: Scherrer constant

λ: wavelength of X-ray used

β: half width at diffraction peak

θ: Bragg angle (half of diffraction angle 2θ)

The hematite-based crystal particle 5 has a small cavity 23 inside the particle as shown in FIGS. 1 and 2B.

It is preferable that the cavity 23 has an opening having a circular shape, and the diameter of the minimum inclusion circle is 5 nm or more and 50 nm or less.

The “minimum inclusion circle” as used herein is minimum virtual circle including all vertices or sides.

The hematite-based crystal particles 5 include particles having a hole formed on the surface, and the hole communicates with the cavity 23. That is, the hematite-based crystal particles 5 include particles in which water enters the cavity 23 through the hole when the photocatalyst electrode 1 is immersed in water.

A method for producing the photocatalyst electrode 1 according to this embodiment will now be described.

First, a hematite raw material, a raw material solvent and a dope raw material are put in a closed vessel and mixed to form a raw material solution. The raw material solution is heated at a predetermined temperature for a predetermined time in a state of being hermetically sealed in the closed vessel, so that crystals are grown to form in-process particles (hematite-based crystal particles before burning) (in-process particle forming step).

The hematite raw material used here is not particularly limited as long as it has iron atoms in the skeleton. Examples of the hematite raw material that can be used include iron(III) halides such as iron fluoride and iron chloride, iron(III) nitrate, iron(III) sulfate, iron complex compounds such as iron alkoxide and iron acetylacetone.

Examples of the raw material solvent that can be used here include organic solvents such as N-dimethylformamide (DMF), N,N-diethylformamide (DEF), formic acid, acetic acid, methanol and ethanol, water, and mixtures thereof. Of these, alcohols such as methanol and ethanol are preferable.

Examples of the dope raw material that can be used here include metal halide salts, metal nitrates, metal sulfates, metal alkoxides and metal complex compounds which contain metals other than iron. Of these, titanium-containing compounds containing titanium, for example, metal halide salts, metal nitrates, metal sulfates, metal alkoxides and metal ex compounds, and TiF₄ as a titanium-containing halide is more preferable, as the dope raw material.

Here, the blending amount of the dope raw material is not particularly limited, and is preferably 0.001 mol or more and 0.5 mol or less in terms of a metal of the dope raw material based on 1 mol of iron of the hematite raw material.

When the blending amount of the dope raw material is within the above-mentioned range, an unreacted dope raw material is hardly generated while the hematite is doped with a metal of the dope raw material.

The heating time here is more than 12 hours after the temperature is raised to the heating temperature, more preferably 15 hours or more. The heating time is preferably 50 hours or less, more preferably 30 hours or less.

When the heating time is within the above-mentioned range, in-process particles of good quality can be formed.

The heating temperature here is preferably equal to or higher than the boiling point, i.e. 100° C. or higher and 200° C. or lower.

When the heating temperature is within the above-mentioned range, hematite-based crystal particles can be efficiently formed.

Subsequently, the in-process particles formed in the in-process particle forming step are dispersed in a dispersion solvent to form a dispersion solution, and the dispersion solution is applied onto the substrate 2 and dried to stack the in-process particles on the substrate 2 (coating step).

The dispersion solvent used here is not particularly limited as long as the in-process particles can be uniformly dispersed, and when dried, the dispersion solvent is volatilized to substantially prevent remaining of components. Examples of the dispersion solvent that can be used include volatile organic solvents such as methanol or ethanol, water, and mixed liquids of organic solvents and water.

The method for coating the substrate 2 with the dispersion solution is not particularly limited. As a method for coating the substrate 2 with the dispersion solution, for example, a spin coating method, a casting method, a spraying method, a dipping method, a printing method or the like can be used.

The substrate 2 coated with the dispersion solution and stacked with the in-process particles is burned for a predetermined burning time at a predetermined burning temperature to form a hematite layer 3 composed of hematite-based crystal particles 5 (burning step). In this way, the photocatalyst electrode 1 is completed.

The burning temperature here is preferably 400° C. or higher, more preferably 500° C. or higher. The burning temperature is preferably 1000° C. or lower, more preferably 900° C. or lower, especially preferably 800° C. or lower.

The burning time here is preferably 1 minute or more and 48 hours or less, more preferably 10 minutes or more and 1 hour or less, after the temperature is raised to the burning temperature.

When the burning temperature and the burning time are within the above-mentioned ranges, respectively, sufficient crystallization is possible, and even when a transparent conductive oxide is used for the transparent conductive layer 11 that forms the substrate 2, degradation of the transparent conductive oxide due to a rise in temperature hardly occurs.

In the method for manufacturing the photocatalyst electrode 1 according to this embodiment, in-process particles are synthesized by solvothermal synthesis, and the synthesized in-process particles are dispersed on the substrate 2, and fixed and sintered. That is, synthesis is performed by an indirect deposition method, so that the synthesis procedure is simple, and industrial mass production is possible. In addition, post-treatment is not required.

In the photocatalyst electrode 1 according to this embodiment, one hematite-based crystal particle 5 is fixed to an adjacent hematite-based crystal particle 5, and therefore good crystallinity is obtained, so that charge transfer resistance can be made smaller than ever before. Thus, as compared to conventional photocatalyst electrodes, recombination of electrons and holes is less likely to occur, and higher catalytic activity is obtained.

In the photocatalyst electrode 1 according to this embodiment, adjacent hematite-based crystal particles 5 and 5 are fixed to each other in a direction intersecting the direction orthogonal to the first main surface, so that charge transfer resistance between the hematite-based crystal particles 5 and 5 can be reduced.

In the photocatalyst electrode 1 according to this embodiment, the hematite-based crystal particle 5a has a flat outer shape, and is fixed in a planar shape to other hematite-based crystal particles 5b and 5c adjacent in a thickness direction. Thus, the contact area between the hematite-based crystal particles 5a and 5b (5a and 5c) can be increased, so that a sufficient conductive path can be secured. As a result, the charge transfer resistance between the hematite-based crystal particles 5 can be suppressed.

In the photocatalyst electrode 1 according to this embodiment, a plurality of hematite-based crystal particles 5 include hematite-based crystal particles 5 having a plurality of cavities 23 inside the particle, so that the photocurrent density per volume can be increased.

In the photocatalyst electrode 1 according to this embodiment, a plurality of hematite-based crystal particles 5 include hematite-based crystal particles having the cavity 23 inside the particle, and having on the surface a hole communicating with the cavity 23. Thus, the inside of the cavity 23 is exposed to water, and light is scattered inside the cavity 23, and therefore the reaction area increases, so that catalytic activity can be improved.

In the photocatalyst electrode 1 according to this embodiment, it is preferable that in the hematite layer 3, four or more cavities provided in the hematite-based crystal particles 5 exist in an area of 500 nm square on a cross-section orthogonal to the first main surface of the substrate 2. In this way, the reaction area per unit weight increases, so that catalytic activity can be improved.

In the photocatalyst electrode 1 according to this embodiment, the hematite layer 3 has a gap 6 extending from the outer surface toward the transparent conductive layer 11 of the substrate 2 through a space between the hematite-based crystal particles 5 and 5, so that water easily enters the gap 6, and light easily reaches a deeper position. As a result, the reaction area per unit weight increases, so that catalytic activity can be improved.

In the photocatalyst electrode 1 according to this embodiment, the hematite-based crystal particles 5 are doped with titanium. Thus, interface resistance can be reduced while high catalytic activity is exhibited.

In the photocatalyst electrode 1 according to this embodiment, the average thickness of the hematite layer 3 can be set to 1.0 μm or more, and even when the hematite layer 3 has such an extremely larger thickness as compared to conventional photocatalyst electrodes, high catalytic activity can be exhibited, and mechanical strength can be secured.

A photocatalyst electrode 100 according to a second embodiment of the present invention will now be described. The same configurations as those of the photocatalyst electrode 1 of the first embodiment are given the same numbers, and the descriptions thereof are omitted. The same applies hereinafter.

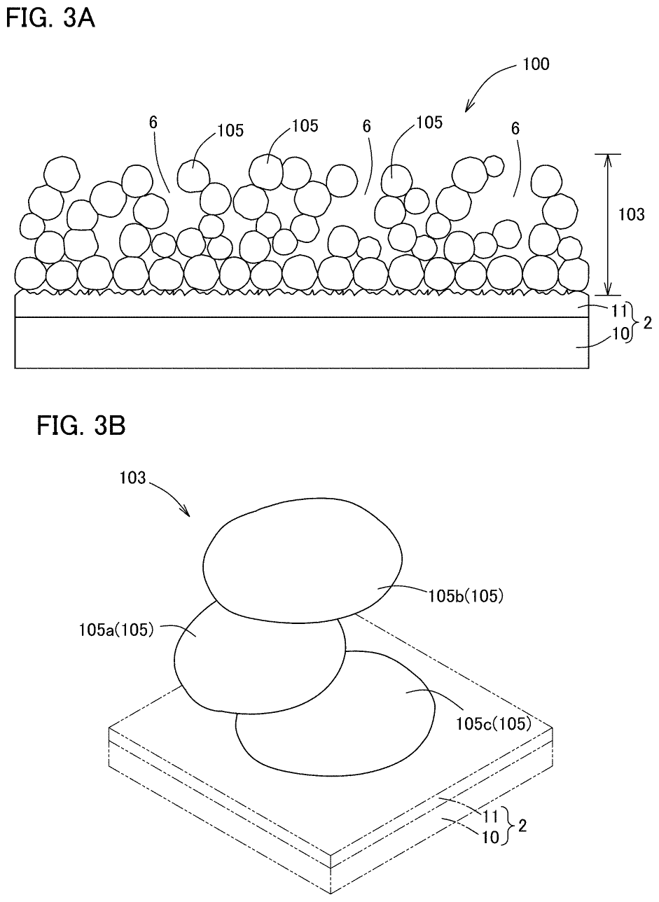

The photocatalyst electrode 100 according to the second embodiment differs from the hematite layer 3 of the first embodiment in that a hematite layer 103 is not doped with titanium. That is, the photocatalyst electrode 100 is one in which the hematite layer 103 is laminated on a substrate 2 as shown in FIG. 3A.

Like the hematite layer 3 according to the first embodiment, the hematite layer 103 is a photocatalyst layer formed by gathering of a large number of hematite-based crystal particles 105, and includes a plurality of gaps 6.

As shown in FIG. 3B, the hematite-based crystal particles 105 are stacked in a thickness direction on the substrate 2, and partially fixed in a planar shape to other hematite-based crystal particles 105 adjacent in the thickness direction.

The hematite-based crystal particles 105 according to this embodiment include a hematite-based crystal particle 105a (first hematite-based crystal particle) sandwiched between other hematite-based crystal particles 105b and 105c (second hematite-based crystal particle and third hematite-based crystal particle) adjacent in the thickness direction as shown in FIG. 3B, and both surfaces of the hematite-based crystal particle 105a are partially fixed to other hematite-based crystal particles 105b and 105c, respectively.

Like the hematite-based crystal particles 5 according to the first embodiment, the hematite-based crystal particles 105 according to this embodiment include particles that are partially fixed to other hematite-based crystal particles 105 in the extending direction of the substrate 2 as shown in FIG. 3A.

The number average particle diameter of the hematite-based crystal particles 105 observed with SEM is preferably 200 nm or more, more preferably 300 nm or more, especially preferably 400 nm or more. The number average particle diameter is preferably 800 nm or less, more preferably 700 nm or less, particularly preferably 600 nm or less.

When the number average particle diameter is within the above-mentioned range, high catalytic activity can be maintained while deterioration during the reaction is suppressed.

The crystallite diameter of the hematite-based crystal particles 105, which is determined by XRD, is preferably 25 nm or more and 35 nm or less.

In the hematite-based crystal particles 105, the ratio of the number average particle diameter to the crystallite diameter is preferably 15 or more. In the hematite-based crystal particle 105, the above-mentioned ratio is preferably 20 or less.

Like the hematite-based crystal particles 5 according to the first embodiment, the hematite-based crystal particles 105 are formed by aggregation and growth of a plurality of crystalline nanoparticle.

The outer surface of the hematite-based crystal particle 105 has a substantially spherical shape or a substantially ellipsoidal shape, and is generally formed by a curved surface.

The “substantially spherical shape or substantially ellipsoidal shape” as used herein is a generally spherical or generally ellipsoidal shape as a whole, and includes tetra-or-higher polyhedral shapes having rounded corners. Specifically, the “substantially spherical shape or substantially ellipsoidal shape” is a shape which can be regarded as a spherical shape or an ellipsoidal shape when observed at a low magnification (for example, 10,000 times).

A method for producing the photocatalyst electrode 100 according to the second embodiment differs from the method for producing the photocatalyst electrode 1 according to the first embodiment in that a dope raw material is not put in a closed vessel in an in-process particle forming step. Other steps are the same as those in the method for producing the photocatalyst electrode 1 according to the first embodiment, and therefore the descriptions thereof are omitted.

A photocatalyst electrode 200 according to a third embodiment of the present invention will now be described.

The photocatalyst electrode 200 according to the third embodiment is different in stacking form of the hematite-based crystal particles from the photocatalyst electrode 1 according to the first embodiment. That is, a hematite-based crystal particles 205 forming a hematite layer 203 according to the third embodiment have crystalline nanoparticles oriented mainly along the (110) plane as compared to the hematite-based crystal particles 5 according to the first embodiment.

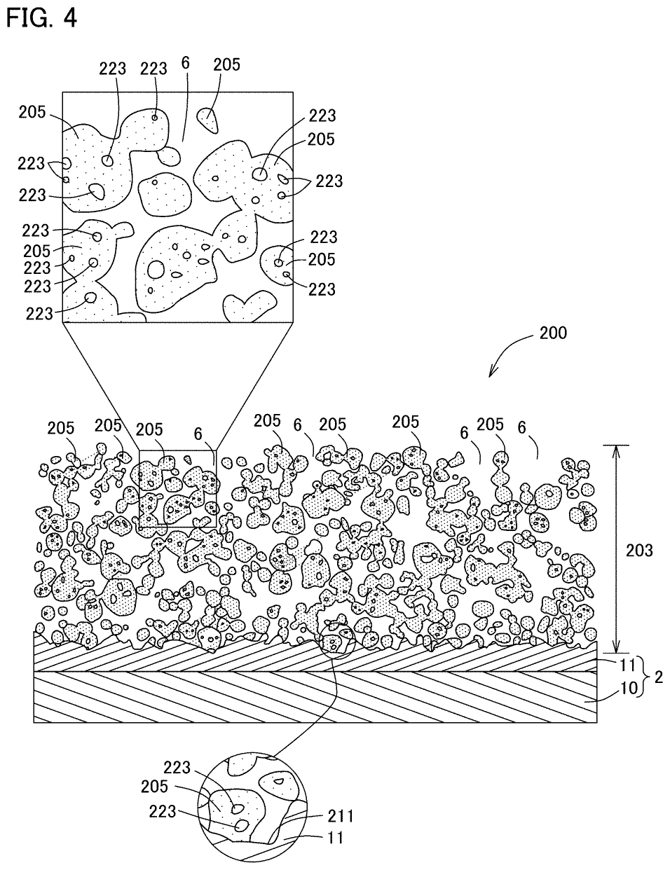

As shown in FIG. 4, the hematite layer 203 is a photocatalyst layer that is formed by gathering of a large number of hematite-based crystal particles 205, and has a plurality of gaps 6.

In the hematite-based crystal particles 205, the cross-section generally has a circular shape, portions other than portions fixed to other hematite crystal particles generally have a spherical shape, and corners are rounded.

The number average particle diameter of the hematite-based crystal particles 205 observed with a scanning electron microscope (SEM) is preferably 50 nm or more, more preferably 100 nm or more. The number average particle diameter of the hematite-based crystal particles 5 is preferably 300 nm or less, more preferably 250 nm or less.

When the number average particle diameter is within the above-mentioned range, high catalytic activity can be maintained while deterioration during the reaction is suppressed.

The crystallite diameter of the hematite-based crystal particles 5, which is determined by X-ray diffraction (XRD) measurement, is preferably 15 nm or more and 25 nm or less.

In the hematite-based crystal particles 205, the ratio of the number average particle diameter to the crystallite diameter is preferably 3 or more. In the hematite-based crystal particle 205, the above-mentioned ratio is preferably 8 or less.

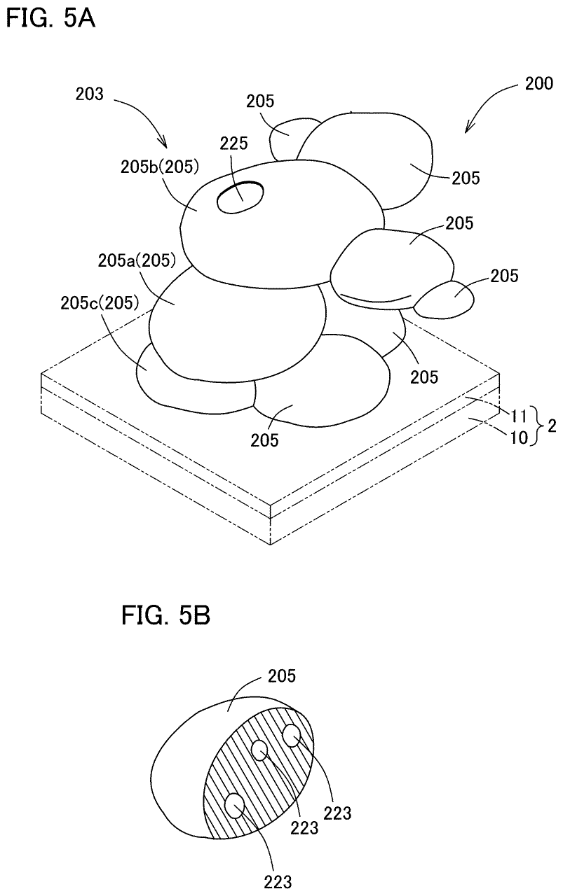

As shown in FIG. 5, the hematite-based crystal particles 205 have an overlapping part with other hematite-based crystal particles 205 when viewed in the thickness direction.

In the hematite layer 203, hematite-based crystal particles 205 having different particle sizes overlap each other, and there are portions in which a hematite-based crystal particle 205 having a small particle size is fixed to a hematite-based crystal particle 205 having a large particle size.

As compared to the hematite layer 3 according to the first embodiment, the hematite layer 203 of this embodiment has a larger number of portions in which the hematite-based crystal particles 205 are fixed together in the extending direction of the substrate 2.

The hematite-based crystal particle 205 has a small cavity 223 inside the particle as shown in FIGS. 4 and 5B.

It is preferable that the cavity 223 has an opening having a circular shape, and the diameter of the minimum inclusion circle is 5 nm or more and 50 nm or less.

The hematite-based crystal particles 205 include particles having a hole 225 formed on the surface, and the hole 225 communicates with the cavity 223. That is, the hematite-based crystal particles 205 include particles in which water enters the cavity 223 through the hole 225 when the photocatalyst electrode 200 is immersed in water.

The diameter of the minimum inclusion circle of the hole 225 is preferably 1 nm or more and 50 nm or less.

In the photocatalyst electrode 200, the surface roughness of the transparent conductive layer 11 on the transparent substrate 10 is rough, and surface irregularities are formed.

The hematite-based crystal particles 205 include particles fixed to the transparent conductive layer 11 in a recessed section 211 of the transparent conductive layer 11 as shown in FIG. 4.

A method for producing the photocatalyst electrode 200 according to the third embodiment will now be described.

In production of the photocatalyst electrode 200 of the third embodiment, the raw material is different from that in the first embodiment.

Specifically, first, an in-process particle forming step is carried out to form in-process particles as in the first embodiment.

In this embodiment, tris(2,4-pentanedionato)iron (III) (Fe(acac)₃) is used as a hematite raw material, TiF₄ is used as a dope raw material, an alcohol such as ethanol is used as a raw material solvent, in the in-process particle forming step.

Other conditions in the in-process particle forming step may be the same as those in the in-process particle forming step for the photocatalyst electrode 1 according to the first embodiment.

After the in-process particle forming step, the particles are washed with acetone, water, methanol or the like if necessary, and a coating step and a burning step are carried out as in the first embodiment to form the photocatalyst electrode 200.

In the photocatalyst electrode 200 according to the third embodiment, the Miller index is oriented along the (110) plane on the substrate 2.

Since the hematite-based crystal particles 205 oriented along the plane are stacked, high photocatalytic activity can be exhibited.

In the photocatalyst electrode 200 according to the third embodiment, some hematite-based crystal particles 205 have a particle diameter smaller than the depth of the recessed section 211 of the transparent conductive layer 11 of the substrate 2, and is fixed to the transparent conductive layer 11 in the recessed section 211. Thus, interface resistance between the transparent conductive layer 11 and the hematite layer 203 can be reduced.

A photocatalyst electrode 300 according to a fourth embodiment of the present invention will now be described.

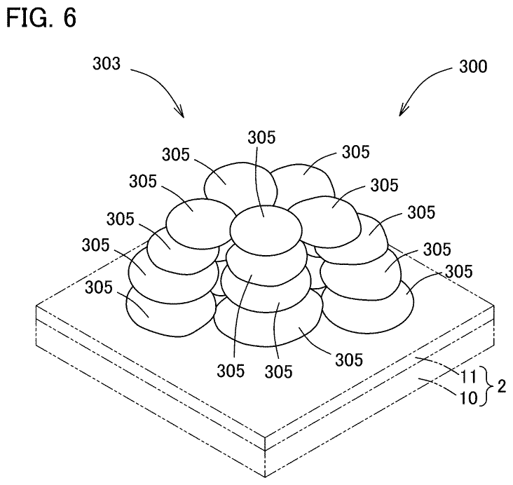

As shown in FIG. 6, a hematite layer 303 of the photocatalyst electrode 300 according to the fourth embodiment is stacked in a thickness direction on the substrate 2, and partially fixed in a planar shape to other hematite-based crystal particles 305 adjacent in the thickness direction.

In the hematite layer 303, the particle diameters of the hematite-based crystal particles 305 are generally equalized, and the hematite-based crystal particles 205 adjacent in a direction intersecting a direction orthogonal to the first main surface of the substrate 2 are preferentially fixed together. That is, in the hematite layer 303, there are many fixed portions of the hematite-based crystal particles 205 in the extending direction of the first main surface.

The number average particle diameter of the hematite-based crystal particles 305 observed with SEM is preferably 50 nm or more, more preferably 75 nm or more. Further, the number average particle diameter is preferably 200 nm or less, more preferably 150 nm or less.

When the number average particle diameter is within the above-mentioned range, high catalytic activity can be maintained while deterioration during the reaction is suppressed.

The crystallite diameter of the hematite-based crystal particles 105, which is determined by XRD, is preferably 15 nm or more and 25 nm or less.

In the hematite-based crystal particles 305, the ratio of the number average particle diameter to the crystallite diameter is preferably 3 or more. In the hematite-based crystal particle 305, the above-mentioned ratio is preferably 8 or less.

A method for producing the photocatalyst electrode 300 according to the fourth embodiment differs from the method for producing the photocatalyst electrode 200 according to the third embodiment in that a dope raw material is not put in a closed vessel in an in-process particle forming step. Other steps are the same as those in the method for producing the photocatalyst electrode 200 according to the third embodiment, and therefore the descriptions thereof are omitted.

A photocatalyst electrode 400 according to a fifth embodiment of the present invention will now be described.

The photocatalyst electrode 400 according to the fifth embodiment of the present invention is produced by a hydrothermal synthesis method which is one type of solvothermal method, and the photocatalyst electrode 400 is different in production method and structure from the photocatalyst electrodes according to the first to fourth embodiments.

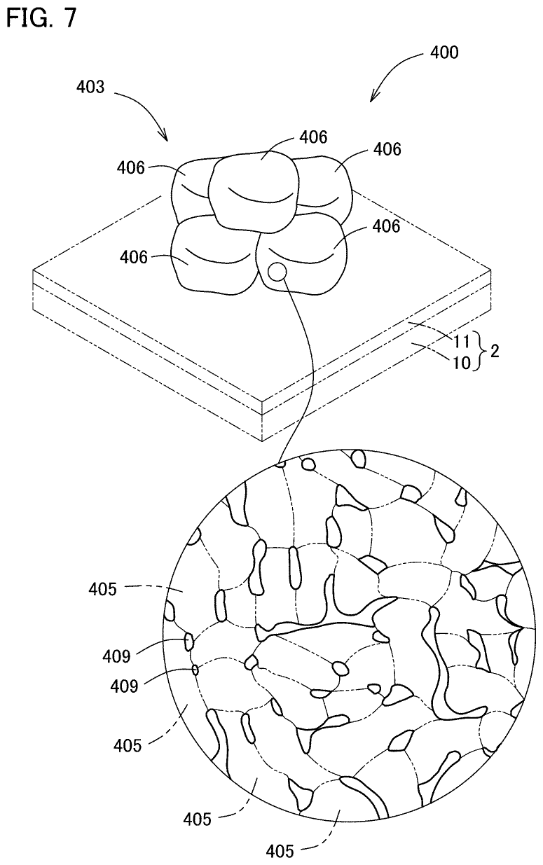

As shown in FIG. 7, the photocatalyst electrode 400 has a hematite layer 403 laminated on a substrate 2.

The hematite layer 403 is a photocatalyst layer formed by gathering of crystal aggregations 406, and a plurality of gaps 6 are formed between the crystal aggregations 406 in the extending direction of the substrate 2.

In the crystal aggregation 406, a large number of hematite-based crystal particles 405 are aggregated, and hematite-based crystal particles 405 are fixed to adjacent hematite-based crystal particles 405.

In the crystal aggregation 406, a large number of hematite-based crystal particles 405 are densely packed, and although there is a slight gap between adjacent hematite-based crystal particles 405 and 405, hematite-based crystal particles 405 are arranged so as to generally fill the crystal aggregation 406.

The crystal aggregation 406 has pores 409 formed at interfaces between the hematite-based crystal particles 405. That is, the pores 409 are derived from gaps between the hematite-based crystal particles 405.

The size of the pore 409 is preferably 2 nm or more and 50 nm or less.

The crystal aggregation 406 has a substantially spherical shape with irregularities provided on the surface, or has substantially corners, with the corners rounded to form a curved surface. That is, the crystal aggregation 406 is not angular as a whole, and has curved end portions.

The hematite-based crystal particles 405 are hematite mesocrystals, and are formed through a process in which nanoparticles grow into a crystal precursor, and the crystal precursor undergoes topotactic transition, whereby crystalline nanoparticles are oriented.

The hematite-based crystal particles 405 are quadrangular particles with rounded corners, or dumbbell-shaped particles in side view. The hematite-based crystal particles 405 include not only particles extending linearly, but also particles bent at a middle part.

The number average particle diameter of the crystal aggregation 406 observed by SEM is preferably 3 μm or more, and is more preferably 4 μm or more. The number average particle diameter is preferably 7 μm or less, and is more preferably 6 μm or less.

When the number average particle diameter is within the above-mentioned range, defects are hardly generated on the surface, and the rising potential can be shifted to a low potential.

The crystallite diameter of the hematite-based crystal particles 405, which is determined by XRD, is preferably 25 nm or more and 35 nm or less.

A method for producing the photocatalyst electrode 400 according to this embodiment will now be described.

In this embodiment, the photocatalyst electrode 400 is produced through a hydrothermal synthesis as a reaction step, and a burning step. Hereinafter, each step will be described in detail.

First, a solution containing a hematite raw material, an ammonium salt, a dope raw material, a surfactant and water (solvent) is put in a closed vessel, and the substrate 2 is immersed in the solution, sealed and heated to form in-process particles (in-process particle forming step and hydrothermal synthesis step).

Here, nanoparticles are generated and grown by hydrothermal reaction in the hydrothermal synthesis step, iron oxyhydroxide (FeOOH) as a crystal precursor is adsorbed onto the substrate to precipitate a crystal of iron oxyhydroxide as hematite crystal precursor on the substrate 2.

Here, as the hematite raw material, one similar to the hematite raw material used in the in-process particle forming step in the first embodiment can be used.

The ammonium salt is not particularly limited as long as it has a function of promoting crystallization of iron oxyhydroxide. Examples of the ammonium salt that can be used include ammonium halides such as ammonium fluoride and ammonium chloride, ammonium nitrate, ammonium perchlorate and ammonium carbonate. The ammonium salt may be used alone, or two or more thereof may be used in combination.

The amount of the ammonium salt used is preferably 1 mol or more and 50 mol or less based on 1 mol of the hematite raw material.

The dope raw material is a metal oxide precursor, and a dope raw material similar to that used in the in-process particle forming step in the first embodiment can be used.

The amount of the dope raw material used is preferably 0.001 mol or more and 0.5 mol or less based on 1 mol of iron contained in the hematite raw material.

The surfactant is not particularly limited, and may be any of anionic surfactants, cationic surfactants, amphoteric surfactants, nonionic surfactants and naturally occurring surfactants (bio-surfactants).

The heating temperature is preferably the boiling point or higher, i.e. 100° C. or higher, more preferably higher than 100° C. The heating temperature is preferably 200° C. or lower.

When the heating is performed at a temperature of higher than 100° C., it is preferable to perform the heating in a closed vessel for preventing loss of water.

The heating time is preferably more than 12 hours after the temperature is raised to the heating temperature, more preferably 15 hours or more. The heating time is preferably 50 hours or less after the temperature is raised to the heating temperature, more preferably 25 hours or less. When the heating time is within the above-mentioned range, hydrothermal reaction can be sufficiently carried out, so that iron oxide can be sufficiently precipitated on the substrate 2. As a result, it is possible to sufficiently densely form a hematite layer 403 on the substrate 2.

Subsequently, the aqueous solution is allowed to cool, the substrate is taken out from the aqueous solution, and the substrate is burned (burning step). The substrate taken out from the aqueous solution may be burned as it is, or may be dried once before being burned.

Hematite crystals are caused to undergo topotactic epitaxial growth while in-process particles of iron oxyhydroxide precipitated on the substrate 2 are formed into hematite (α-Fe₂O₃) through the following reaction (2) in the burning step.

2FeOOH→Fe₂O₃+H₂O (2)

The “topotactic” as used herein means that the basic skeleton is maintained.

The “epitaxial growth” as used herein means that crystals are grown in the same direction.

That is, in the burning step, crystals particularly on the surface of iron oxyhydroxide precipitated on the substrate 2 are grown in the (110) plane direction.

Here, the burning temperature is preferably 400° C. or higher, more preferably 500° C. or higher, especially preferably 600° C. or higher.

The burning temperature is preferably 1000° C. or lower, more preferably 900° C. or lower, especially preferably 800° C. or lower.

The burning time is preferably 1 minute or more and 48 hours or less, more preferably 1 hour or less, after the temperature is raised to the burning temperature.

In the method for producing the photocatalyst electrode 400 according to this embodiment, iron oxide is sufficiently densely precipitated on the substrate 2 through hydrothermal reaction step. Thus, the hematite layer 403 obtained in the sintering step can be made sufficiently dense.

In the method for producing the photocatalyst electrode 400 according to this embodiment, the crystals are caused to undergo topotactic epitaxial growth and grow in the same direction in the hydrothermal synthesis step. Thus, the hematite-based crystal particles 405 forming the hematite layer 403 can be regularly integrated on the substrate 2.

In the method for producing the photocatalyst electrode 400 according to this embodiment, in-process particles are formed with the hematite raw material present in the closed vessel together with the substrate 2, and the in-process particles on the substrate 2 are then sintered, in the hydrothermal synthesis step which is the in-process particle forming step.

That is, since the photocatalyst electrode 400 according to this embodiment is synthesized by a direct deposition method, the hematite-based crystal particles 405 formed on the substrate 2 can be regularly oriented with respect to the substrate 2. Thus, particle boundary resistance and interface resistance can be reduced.

In the method for producing the photocatalyst electrode 400 according to this embodiment, the in-process particles are produced by a hydrothermal synthesis method, and therefore the photocatalyst electrode can be produced at a relatively low temperature, and hence at lower cost and with higher efficiency than ever before.

In the photocatalyst electrode 400 according to this embodiment, a plurality of hematite-based crystal particles 405 forms one crystal aggregation 406, and the crystal aggregation 406 has pores 409 formed at the interfaces between adjacent hematite-based crystal particles 405 and 405. Thus, water easily enters the pores 409, so that catalytic activity can be improved.

A photocatalyst electrode 500 according to a sixth embodiment of the present invention will now be described.

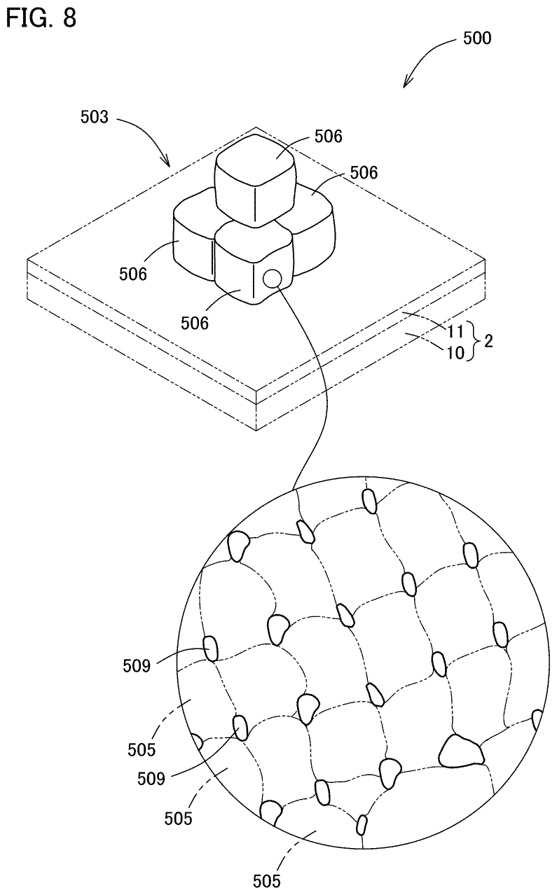

The photocatalyst electrode 500 according to the sixth embodiment is different from the hematite layer 403 according to the fifth embodiment in that a hematite layer 503 is not doped with titanium. That is, the photocatalyst electrode 500 has the hematite layer 503 laminated on a substrate 2 as shown in FIG. 8.

Like the hematite layer 403 according to the fifth embodiment, the hematite layer 503 is a photocatalyst layer formed by gathering of crystal aggregations 506.

In the crystal aggregation 506, a large number of hematite-based crystal particles 505 are aggregated, and hematite-based crystal particles 505 are fixed to adjacent hematite-based crystal particles 505.

The crystal aggregation 506 has a substantially spherical shape with irregularities provided on the surface, or a substantially polyhedral shape, or has substantially corners, with the corners rounded to form a curved surface. That is, the crystal aggregation 506 is not angular and has curved end portions.

In the crystal aggregation 506, a large number of hematite-based crystal particles 505 are densely packed, and although there is a slight gap between adjacent hematite-based crystal particles 505 and 505, hematite-based crystal particles 505 are arranged so as to generally fill the crystal aggregation 506.

The crystal aggregation 506 has pores 509 formed on the surface. That is, the pores 509 are derived from gaps between the hematite-based crystal particles 505.

The diameter of the minimum inclusion circle of the pore 509 is preferably 2 nm or more and 50 nm or less.

The number average particle diameter of the crystal aggregation 506 observed with SEM is preferably 1 μm or more, more preferably 3 μm or more. The number average particle diameter is preferably 5 μm or less.

When the number average particle diameter is within the above-mentioned range, defects are hardly generated on the surface, and the rising potential can be shifted to a low potential.

The crystallite diameter of the hematite-based crystal particles 505, which is determined by XRD, is preferably 25 nm or more and 35 nm or less.

A method for producing the photocatalyst electrode 500 according to the sixth embodiment differs from the method for producing the photocatalyst electrode 400 according to the fifth embodiment in that a dope raw material is not put in a closed vessel in a hydrothermal synthesis step. Other steps are the same as those in the method for producing the photocatalyst electrode 400 according to the fifth embodiment, and therefore the descriptions thereof are omitted.

In the above-described embodiments, a transparent conductive substrate with the transparent conductive layer 11 laminated on the transparent substrate 10 is used as the substrate 2, and the present invention is not limited to thereto. The substrate may be a conductive plate such as a metal plate or a metal oxide plate. That is, the substrate 2 is not required to be transparent as long as the hematite layer and the like can be irradiated with light.

In the above-described first, third and fifth embodiments, the hematite-based crystal particles 5, 205 and 405 are doped with titanium, and the present invention is not limited thereto. The particles may be doped with another metal. For example, the particles may be doped with at least one n-type dopant selected from the group consisting of Si, Ge, Pb, Zr, Hf, Sb, Bi, V, Nb, Ta, Mo, Tc, Re, Sn, Pb, N, P, As and C, or at least one p-type dopant selected from the group consisting of Ca, Be, Mg, Sr and Ba.

In the above-described embodiments, the case where the photocatalyst electrode is used as an anode electrode of a water photolysis cell has been described, and the present invention is not limited thereto. The photocatalyst electrode may be used for other purposes. For example, the photocatalyst electrode may be used as an electrode of a solar cell, a fuel cell, a secondary battery or the like.

In the above-described fifth and sixth embodiments, the photocatalyst electrode is produced by a hydrothermal synthesis method using water as a solvent, and the present invention is not limited thereto. The photocatalyst electrode may be produced by another solvothermal method using a solvent other than water.

As an application example of the above-described embodiment, a promoter may be carried on the photocatalyst electrode. As the promoter, for example, cobalt phosphate (Co-Pi) or the like can be preferably used.

By carrying the promoter, the rising potential can be shifted to a low potential, and catalytic activity can be improved.

The constituent members may be freely replaced or added among the above-described embodiments without departing from the technical scope of the present invention.

Hereinafter, the present invention will be described in detail by way of experimental examples. It should be noted that the present invention is not limited to the following experimental examples, and changes can be made as appropriate without departing from the spirit of the present invention.

### Experimental Example 1-1

First, 1.0 mmol of Fe(NO₃)₃.9H₂O (99.9%) (manufactured by Wako Pure Chemical Industries, Ltd.), 0.1 mmol of TiF₄ (99.9%) (manufactured by Sigma-Aldrich Co. LLC), 40 mL of DMF (99.9%) (manufactured by Wako Pure Chemical Industries, Ltd.) and 10 mL of methanol (99.8%) (manufactured by NACALAI TESQUE, INC.) were put in a 100 mL polytetrafluoroethylene container (hereinafter, also referred to as a PTFE container), and stirred to be mixed. The PTFE container was placed in a pressure-resistant stainless steel closed vessel, and sealed, and the mixture was heated at 180° C. for 24 hours, and then naturally cooled to form in-process particles (hematite-based crystal particles before burning).

The formed in-process particles were dispersed in methanol and water to form a dispersion solution, the dispersion solution was applied to a substrate with fluorine-doped tin oxide deposited on a glass substrate (hereinafter, also referred to as an FTO substrate) using a spin coater in such a manner that the dry thickness was 1.2 μm, and the applied dispersion solution was dried.

The FTO substrate with the in-process particles laminated thereon was burned at 700° C. for 20 minutes to deposit a hematite layer, thereby forming a photocatalyst electrode. The photocatalyst electrode thus obtained was defined as Experimental Example 1-1.

### Experimental Example 1-2

Except that the formed in-process particles were dispersed in methanol and water to form a dispersion solution, the dispersion solution was applied to an FTO substrate using a spin coater in such a manner that the dry thickness was 1.6 μm, and the applied dispersion solution was dried, the same procedure as in Experimental Example 1-1 was carried out to form a photocatalyst electrode. The photocatalyst electrode was defined as Experimental example 1-2.

### Experimental Example 2

Except that TiF₄ was not put in the PTFE container, and 1.0 mmol of Fe(NO₃)₃.9H₂O, 40 mL of DMF and 10 mL of methanol were put in the PTFE container, and mixed, the same procedure as in Experimental Example 1-1 was carried out to form a photocatalyst electrode. The photocatalyst electrode thus obtained was defined as Experimental Example 2.

### Comparative Example 1

Except that 1.0 mmol of Fe(NO₃)₃.9H₂O, 48 mL of DMF and 2 mL of methanol were put in the PTFE container, and mixed, the same procedure as in Experimental Example 2 was carried out to form a photocatalyst electrode.

The photocatalyst electrode thus obtained was defined as Comparative Example 1.

### Experimental Example 3

First, 1.0 mmol of Fe(acac)₃ (manufactured by FUJIFILM Wako Pure Chemical Corporation), 19.95 mL of ethanol and 12.4 mg of TiF₄ were added, and then 50 μL of distilled water were put in a PTFE container, and mixed. The PTFE container was placed in a pressure-resistant stainless steel closed vessel, and sealed, and the mixture was heated at 180° C. for 24 hours, and then naturally cooled to form in-process particles (hematite-based crystal particles before burning).

The formed in-process particles were washed with acetone, water and methanol, and dispersed in methanol to form a dispersion solution, the dispersion solution was applied to an FTO substrate using a spin coater in such a manner that the dry thickness was 1.6 μm, and the applied dispersion solution was dried.

The FTO substrate with the in-process particles laminated thereon was burned at 700° C. for 20 minutes to deposit a hematite layer, thereby forming a photocatalyst electrode. The photocatalyst electrode thus obtained was defined as Experimental Example 3.

### Experimental Example 4

Except that TiF₄ was not put in the PTFE container, and 1.0 mmol of Fe(acac)₃ and 19.95 mL of ethanol, and then 50 μL of distilled water were put in the PTFE container, and mixed, the same procedure as in Experimental Example 3 was carried out to form a photocatalyst electrode. The photocatalyst electrode thus obtained was defined as Experimental Example 4.

### Experimental Example 5

First, 0.5 mmol of FeCl₃ (manufactured by FUJIFILM Wako Pure Chemical Corporation), 6 mmol of NH₄F (manufactured by FUJIFILM Wako Pure Chemical Corporation), 3 mmol of NH₄NO₃ (manufactured by FUJIFILM Wako Pure Chemical Corporation) and 10 mL of distilled water were put in a PTFE container, and mixed. The PTFE container was placed in a pressure-resistant stainless steel closed vessel, and sealed, and the mixture was heated at 100° C. for 18 hours to form a precursor of hematite-based crystal particles (in-process particles) on an FTO substrate. Thereafter, the FTO substrate was taken out from the PTFE container, and burned at 700° C. for 10 minutes to deposit a hematite layer on the FTO substrate, thereby forming a photocatalyst electrode. The photocatalyst electrode thus obtained was defined as Experimental Example 5.

### Comparative Example 2

Except that the time for hydrothermal reaction at 100° C. was changed from 18 hours to 12 hours, the same procedure as in Experimental Example 5 was carried out to form a photocatalyst electrode. The photocatalyst electrode thus obtained was defined as Comparative Example 2.

### Experimental Example 6

Except that 0.45 mmol of FeCl₃, 6 mmol of NH₄F, 3 mmol of NH₄NO₃, 0.05 mmol of TiF₄ and 10 mL of distilled water were put in the PTFE container, and mixed, the same procedure as in Experimental Example 5 was carried out to form a photocatalyst electrode. The photocatalyst electrode thus obtained was defined as Experimental Example 6.

### Comparative Example 3

Fe(NO₃)₃.6H₂O, NH₄F and NH₄NO₃ were taken at a molar ratio of 1:12:6, and added in the agate mortar using a stainless spatula, and ground and mixed with a pestle until the color of the mixture turned white, thereby obtaining a white paste. The FTO substrate was rotated with a spin coater, the prepared white paste was dropped onto the FTO substrate, and a thin film of the paste was formed on the FTO substrate. This was heated at 10° C./min and burned at 550° C. for 2 hours in an electric furnace to form a photocatalyst electrode. The photocatalyst electrode thus obtained was defined as Comparative Example 3.

### Experimental Example 7

Co-Pi as a promoter was carried on the photocatalyst electrode of Experimental Example 1-2 to form a photocatalyst electrode. The photocatalyst electrode thus obtained was defined as Experimental Example 7.

### Experimental Example 8

Co-Pi as a promoter was carried on the photocatalyst electrode of Experimental Example 3 to form a photocatalyst electrode. The photocatalyst electrode thus obtained was defined as Experimental Example 8.

(Evaluation of Surface Structure)

(a) XRD Diffraction Measurement

For the photocatalyst electrodes of Experimental Examples 1 to 6 and Comparative Examples 1 to 3, an X-ray diffraction peak was measured by X-ray diffraction (XRD) using a CuKα ray (CuKα=1.542 Å), the crystal structure was evaluated from the obtained X-ray diffraction peak, and the crystallite diameter was evaluated from the X-ray diffraction peak in accordance with the Scherrer formula (1).

(b) Observation with Scanning Electron Microscope

Cross sections of the photocatalyst electrodes of Experimental Examples 1-1, 1-2 and 3 were observed with a scanning electron microscope (SEM). The surfaces of the hematite layers of Experimental Examples 1-2 and 2 to 6 and Comparative Examples 1 and 2 were observed with SEM.

(c) Observation with Transmission Electron Microscope

The surfaces of the hematite-based crystal particles before and after burning in Experimental Example 1 were observed with a transmission electron microscope (TEM), and a selected area electron diffraction (SAED) image was also observed. Further, elemental mapping for each of Fe, O, and Ti was performed on one hematite-based crystal particle by EDX measurement.

Table 1 shows the results of evaluation of the surface structure.

The crystallite diameter in Table 1 was calculated from the X-ray diffraction peak of the (104) plane for Experimental Examples 1-1, 2, 5 and 6 and Comparative Examples 1 to 3, and from that of the (110) plane for Experimental Examples 3 and 4.

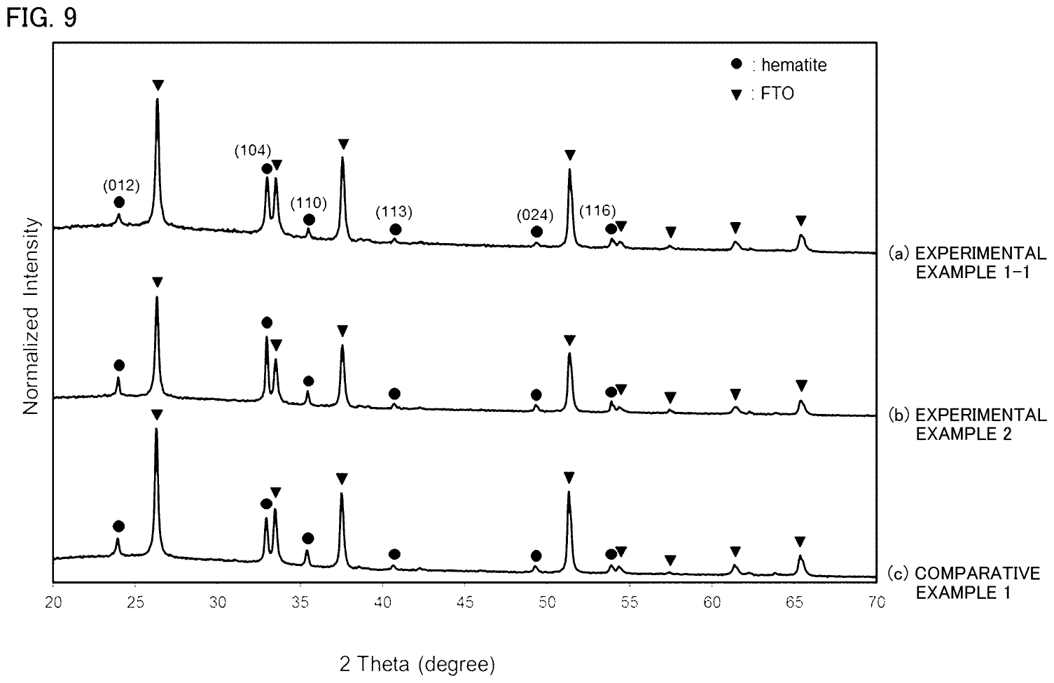

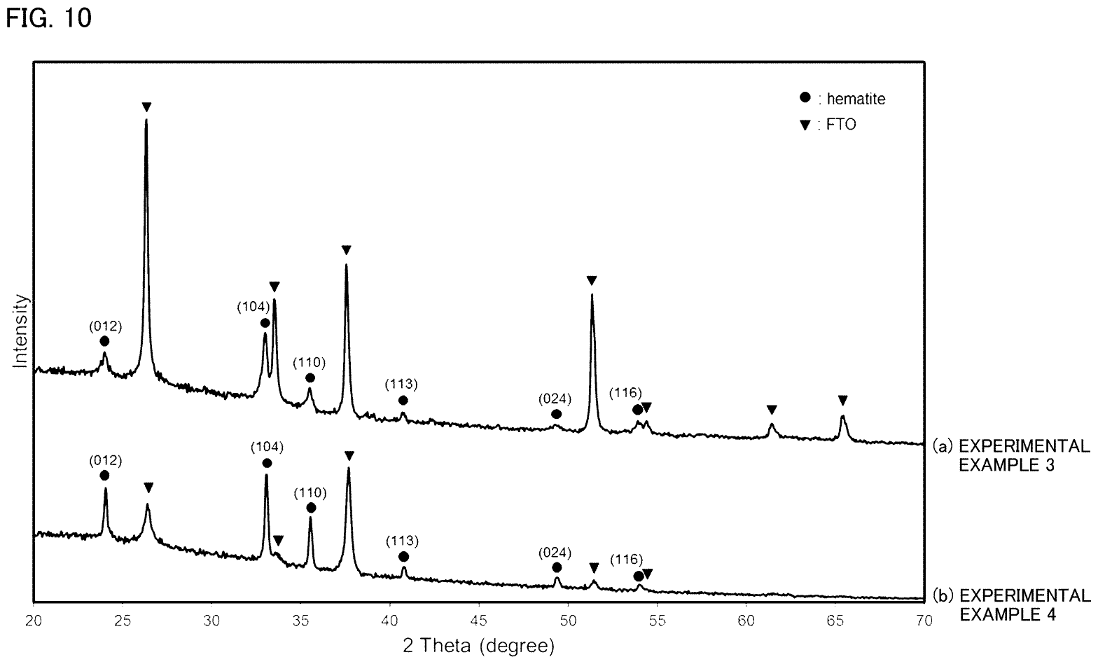

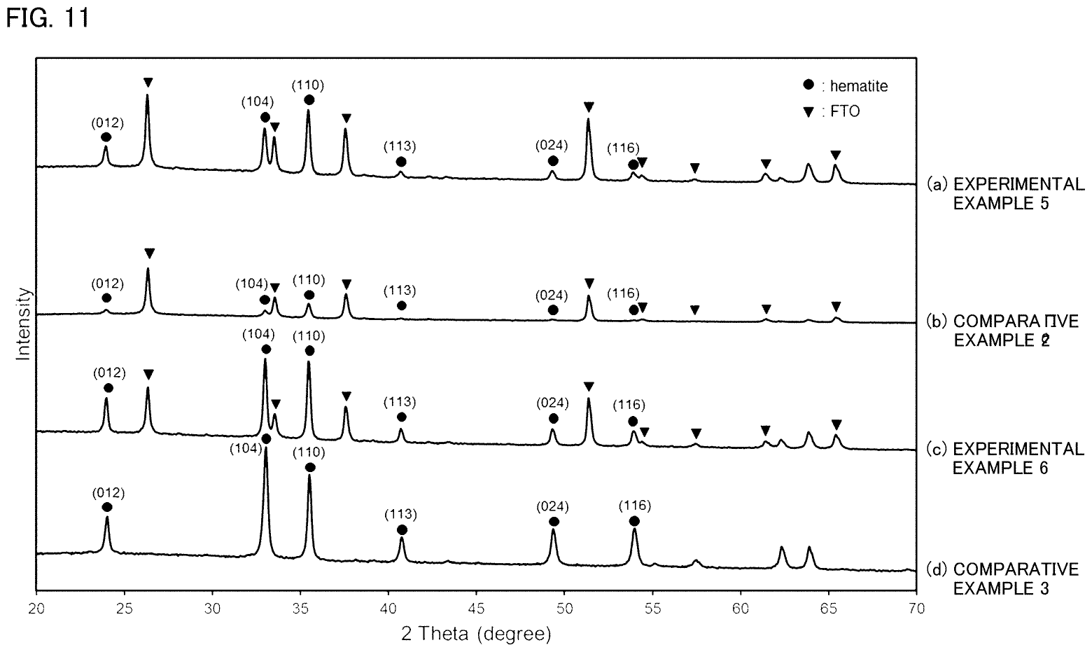

FIGS. 9 to 11 show the results obtained by the powder XRD measurement of the photocatalyst electrodes of Experimental Examples 1-1 and 2 to 6 and Comparative Examples 1 to 3.

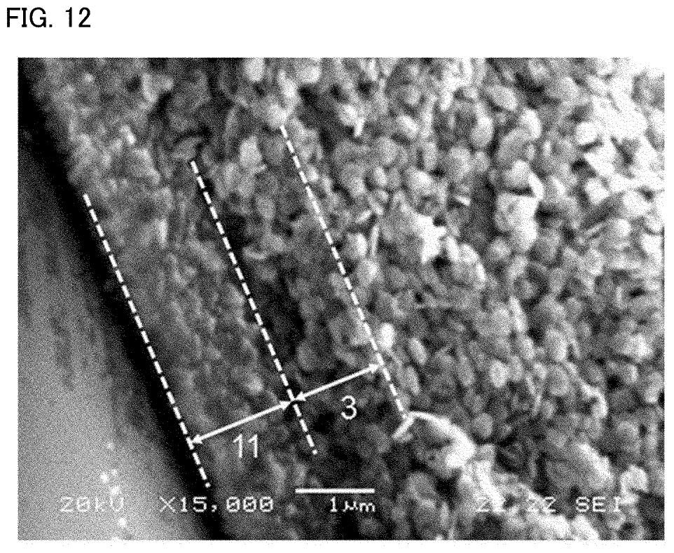

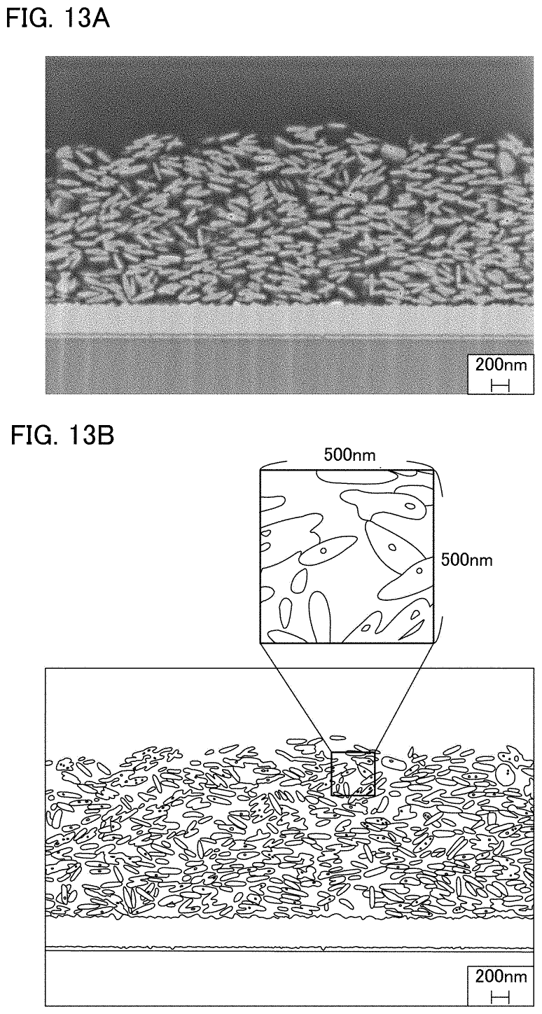

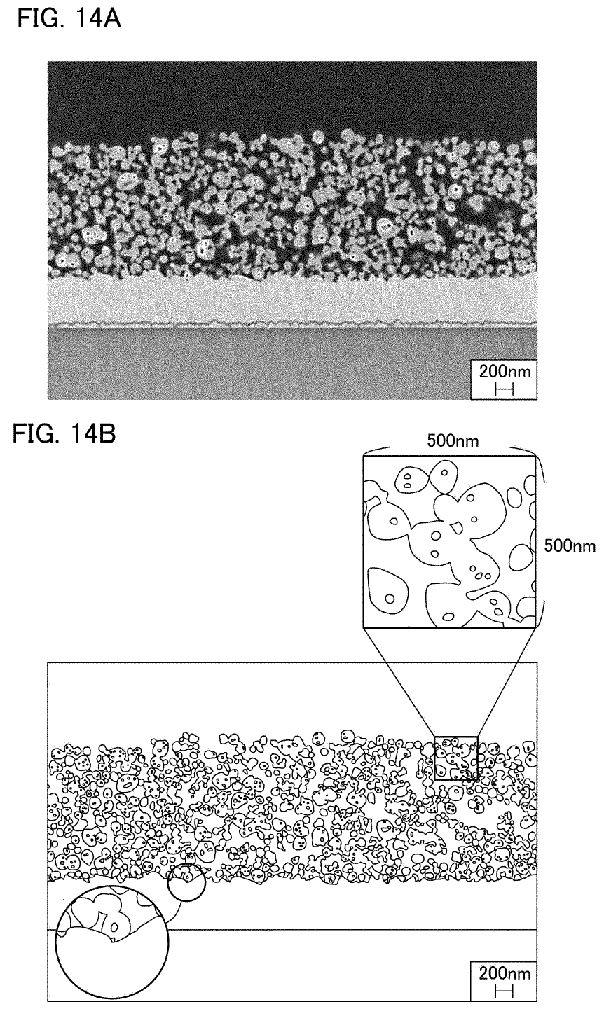

FIG. 12 shows a cross-section of the photocatalyst electrode of Experimental Example 1-1, FIG. 13 shows a cross-section of the photocatalyst electrode of Experimental Example 1-2, and FIG. 14 shows a cross-section of the photocatalyst electrode of Experimental Example 3.

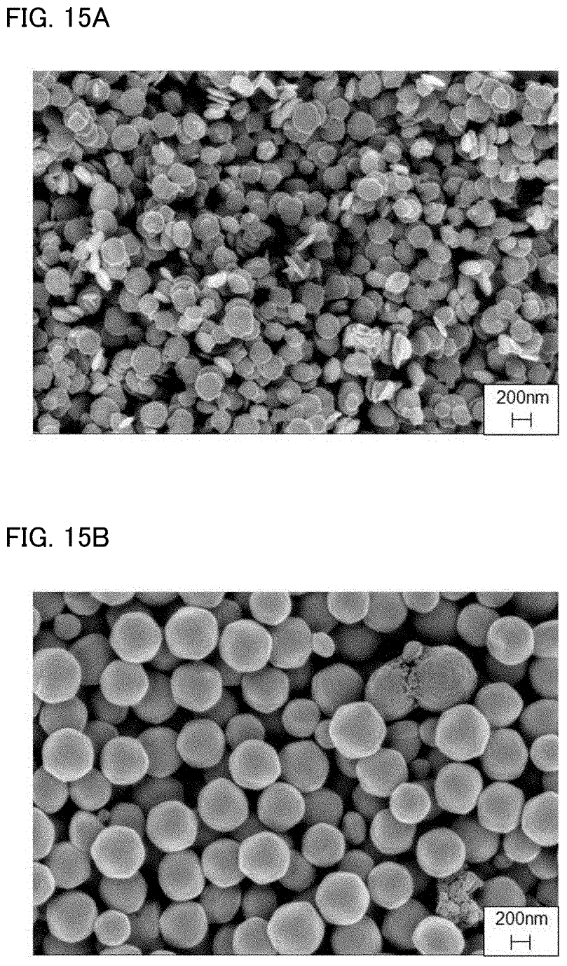

FIGS. 15 to 27 show SEM images of the photocatalyst electrodes of Experimental Examples 1-2, 2 to 6 and Comparative Examples 1 and 3.

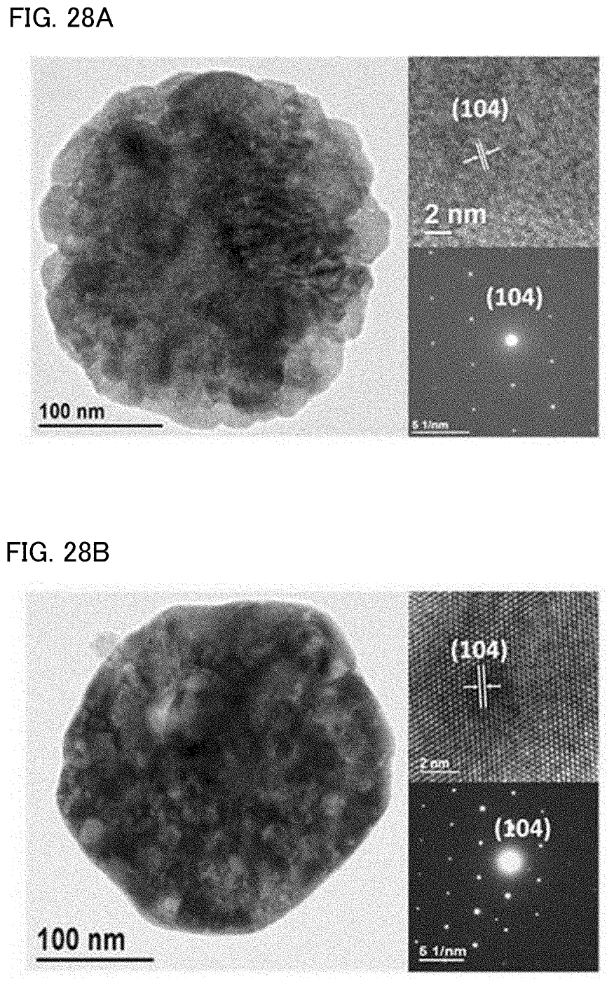

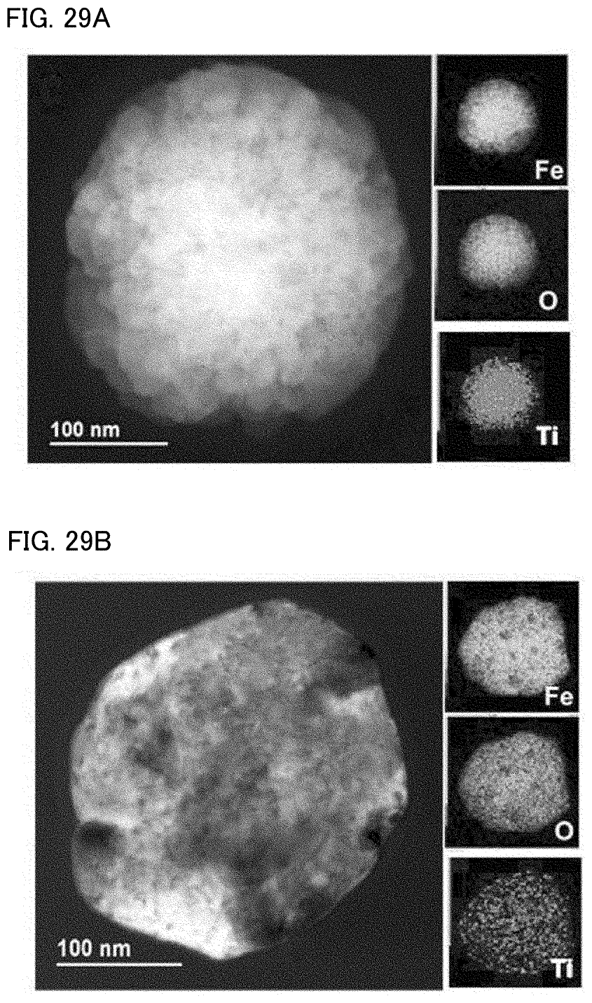

FIG. 28 shows a TEM image and an SEAD image of the hematite-based crystal particles of Experimental Example 1, and FIG. 29 shows the results of mapping by EDX measurement.

TABLE 1

| | Crystallite | Peak Intensity | |
|---|---|---|---|
| | Diameter | Ratio | |
| | (nm) | (110)/(104) | Ti Dope |
| Experimental | 28 | 0.37 | Done (8.5%) |
| Example 1-1 | | | |
| Experimental | 29 | 0.35 | Not Done |
| Example 2 | | | |
| Experimental | 19 | 0.55 | Done |
| Example 3 | | | |
| Experimental | 22 | 0.67 | Not Done |
| Example 4 | | | |
| Experimental | 32 | 0.67 | Not Done |
| Example 5 | | | |
| Experimental | 33 | 1.03 | Done |
| Example 6 | | | |
| Comparative | 31 | 0.50 | Not Done |
| Example 1 | | | |
| Comparative | 30 | 0.48 | Not Done |
| Example 2 | | | |
| Comparative | 6 | 1.35 | Not Done |
| Example 3 | | | |

(a) Results of XRD Diffraction Measurement

In Experimental Examples 1-1 and 2 to 6, and Comparative Examples 1 to 3, as shown in FIGS. 9 to 11, a peak corresponding to the (012) plane is detected at a 2θ of 23° to 24°, a peak corresponding to the (104) plane was detected at a 2θ of 32° to 33°, a peak corresponding to the (110) plane is detected at a 2θ of 35° to 36°, a peak corresponding to the (113) plane was detected at a 2θ of 40° to 41°, a peak corresponding to the (024) plane is detected at a 2θ of 49° to 50°, and a peak corresponding to the (116) plane was detected at a 2θ of 53.5° to 54°, as peaks derived from hematite. Hereupon, (abc) represents a Miller index.

In Experimental Examples 1 to 6 and Comparative Examples 1 and 2, a peak is detected at each of 2θs of 26° to 27°, 33° to 34°, 37° to 38°, 51° to 52°, 54° to 55°, 57° to 58°, 61° to 62° and 65° to 66° as peaks derived from the FTO substrate.

This shows that a hematite layer is formed in all of Experimental Examples 1 to 6 and Comparative Examples 1 to 3, and a hematite layer having hematite as a basic skeleton is laminated on the FTO substrate in Experimental Examples 1 to 6 and Comparative Examples 1 and 2.

It was found that the hematite layers of Experimental Examples 1-1 and 2 have a smaller peak intensity ratio of the (110) plane to the (104) plane as compared to the single crystal of Comparative Example 1 as shown in Table 1, and are oriented along the (104) plane. On the other hand, it was found that the hematite layers of Experimental Examples 3 and 4 have a larger peak intensity ratio of the (110) plane to the (104) plane as compared to the single crystal of Comparative Example 1, and are oriented along the (110) plane.

It was found that the hematite layers of Experimental Examples 5 and 6 have a larger peak intensity ratio of the (110) plane to the (104) plane as compared to Comparative Example 2 with a heating time of 12 hours, and are oriented along the (110) plane.

The hematite layer of Experimental Example 1-1 which is doped with titanium has a larger peak intensity ratio of the (110) plane to the (104) plane of the hematite-based crystal particle as compared to the hematite layer of Experimental Example 2 which was not doped with titanium.

On the other hand, the hematite layer of Experimental Example 3 which was doped with titanium have a smaller peak intensity ratio of the (110) plane to the (104) plane of the hematite-based crystal particle as compared to the hematite layer of Experimental Example 4 which was not doped with titanium.

The hematite layer of Experimental Example 6 which was doped with titanium have a larger peak intensity ratio of the (110) plane to the (104) plane of the hematite-based crystal particle as compared to the hematite layer of Experimental Example 5 which was not doped with titanium.

The crystallite diameter in each of Experimental Examples 1-1 and 2 is larger than the crystallite diameter of the hematite layer of each of Experimental Examples 3 and 4 with the hematite layer oriented mainly along the (110) plane, and is equivalent to the crystallite diameter of the hematite layer of each of Experimental Examples 5 and 6 which was formed by a hydrothermal synthesis method.

(b) Results of Observation with Scanning Electron Microscope

In the photocatalyst electrode of Experimental Example 1-1, a large number of hematite-based crystal particles are stacked on the FTO substrate to form a hematite layer as shown in FIG. 12, and the average thickness of the hematite layer is about 1.2 μm.

In the photocatalyst electrode of Experimental Example 1-2, a large number of flat hematite-based crystal particles are stacked on the FTO substrate to form a hematite layer as shown in FIG. 13, and the average thickness of the hematite layer is about 1.6 μm. The hematite layer of Experimental Example 1-2 is generally regularly stacked in such a manner that the thickness direction of hematite-based crystal particles is orthogonal to the FTO substrate, and adjacent hematite-based crystal particles are fixed in a state of overlapping mainly in the thickness direction.

In the photocatalyst electrode of Experimental Example 1-2, most hematite-based crystal particles have cavities formed inside the particle as is apparent from FIG. 13 showing one cross-section. In the photocatalyst electrode of Experimental Example 1-2, a plurality of hematite-based crystal particles exist in, for example, an area 500 nm in both length and width, which is magnified in FIG. 13, and the number of cavities formed in the hematite-based crystal particle is eight.

In the photocatalyst electrode of Experimental Example 3, a large number of hematite-based crystal particles with a cross-section having a substantially circular shape are stacked on the FTO substrate to form a hematite layer as shown in FIG. 14, and the average thickness of the hematite layer is about 1.6 μm. The hematite layer of Experimental Example 3 is generally regularly stacked in the thickness direction, and adjacent hematite-based crystal particles are preferentially fixed mainly in a direction intersecting a direction orthogonal to the FTO substrate.

In the photocatalyst electrode of Experimental Example 3, most hematite-based crystal particles have cavities formed inside the particle as is apparent from FIG. 14 showing one cross-section. In the photocatalyst electrode of Experimental Example 3, a plurality of hematite-based crystal particles exist in, for example, an area 500 nm in both length and width, which is magnified in FIG. 14, and the number of cavities formed in the hematite-based crystal particle is 15.

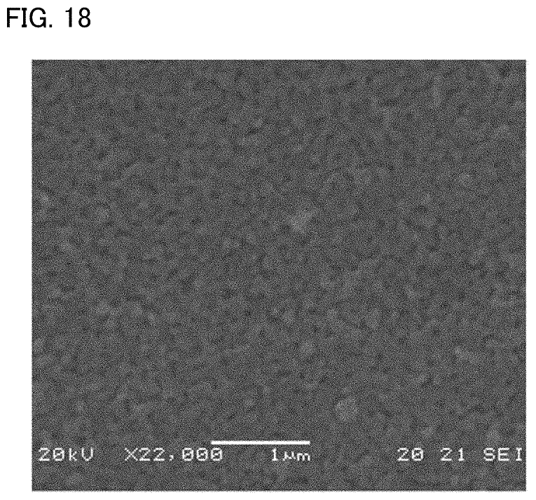

In the single crystal of Comparative Example 1, the crystallite diameter calculated in XRD measurement is generally identical to the particle diameter of the hematite-based crystal particle observed with SEM, as shown in Table 1 and FIG. 18.

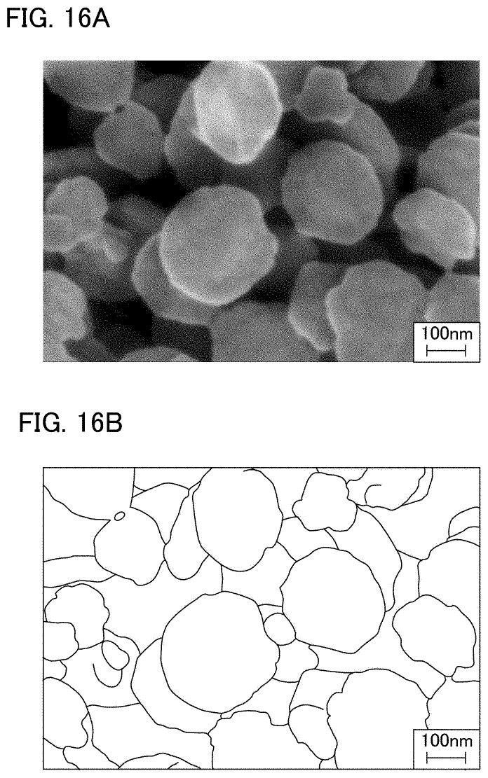

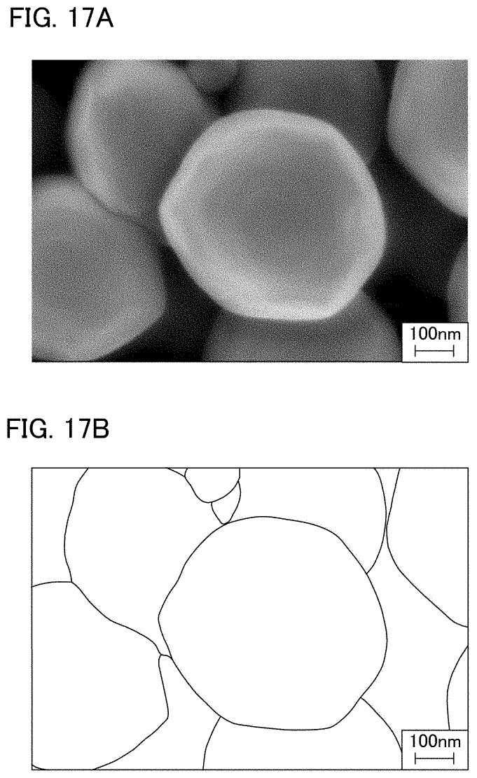

On the other hand, in the photocatalyst electrodes of Experimental Examples 1-1 and 2, the crystallite diameter calculated in XRD measurement is about 30 nm as shown in Table 1, whereas in the SEM images shown in FIGS. 16 and 17, only hematite-based crystal particles having a primary particle diameter of about 300 to 600 nm are observed.

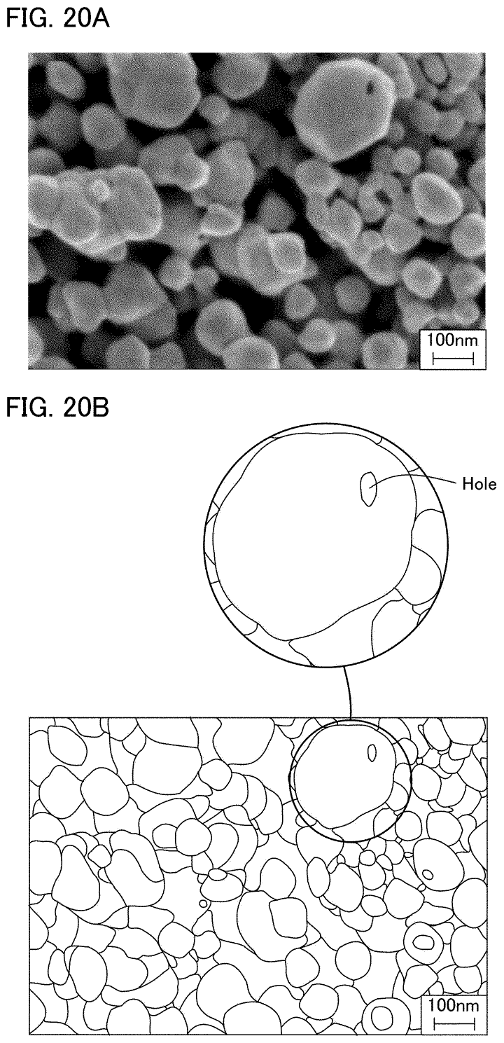

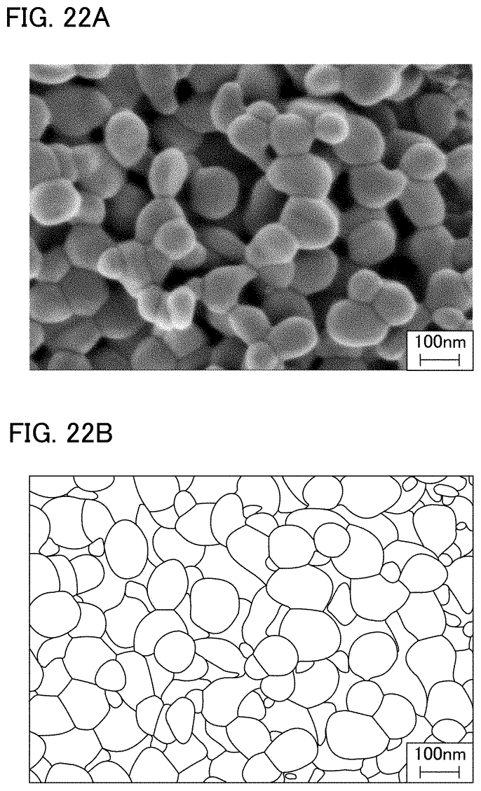

In the photocatalyst electrodes of Experimental Examples 3 and 4, the crystallite diameter calculated in XRD measurement is about 20 nm as shown in Table 1, whereas in the SEM images shown in FIGS. 20 and 22, only hematite-based crystal particles having a primary particle diameter of about 50 to 200 nm are observed.

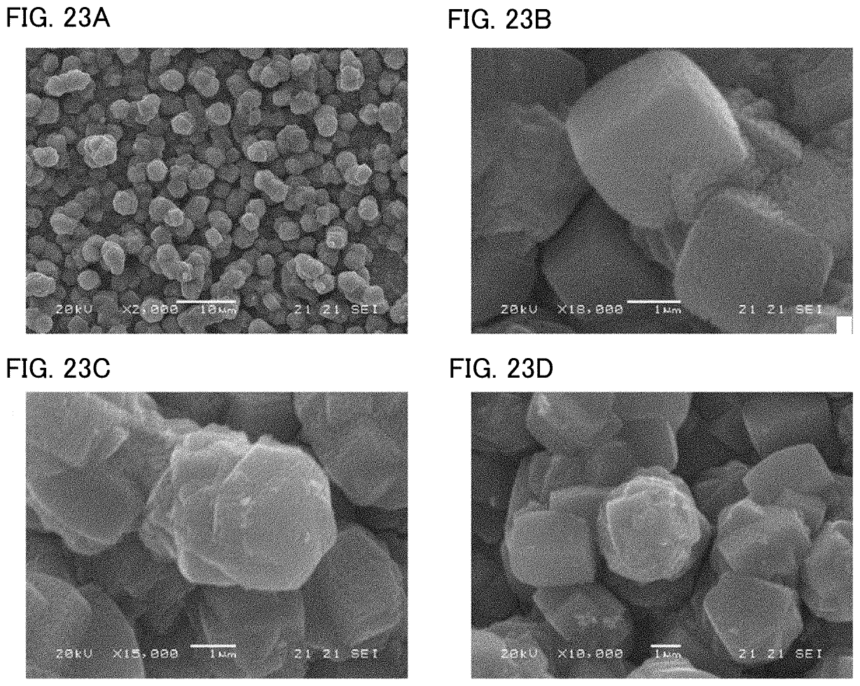

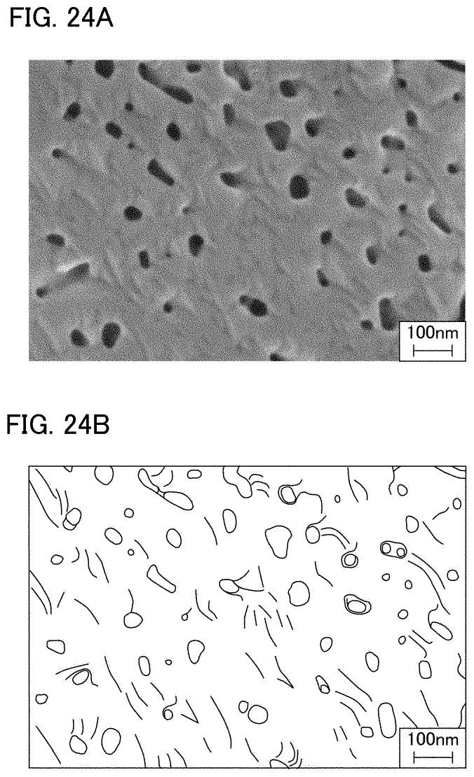

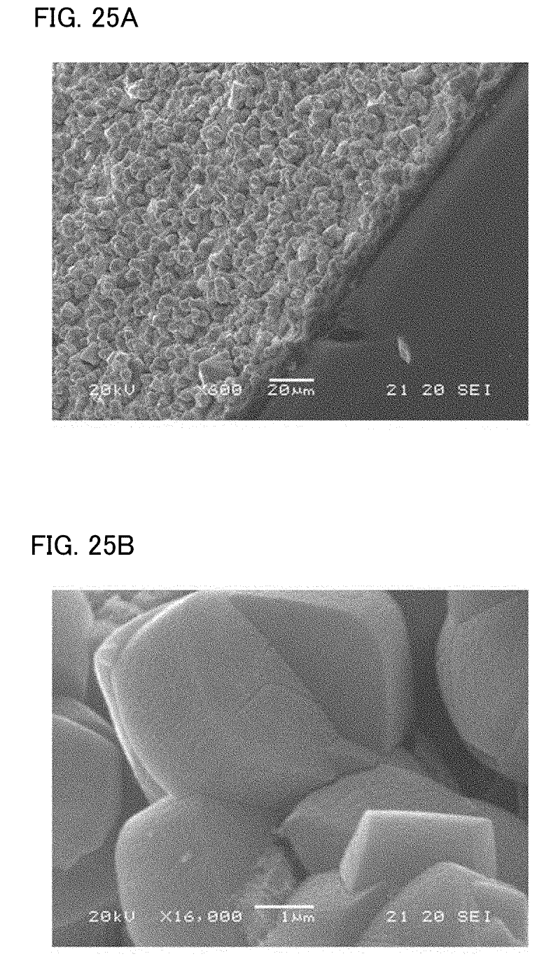

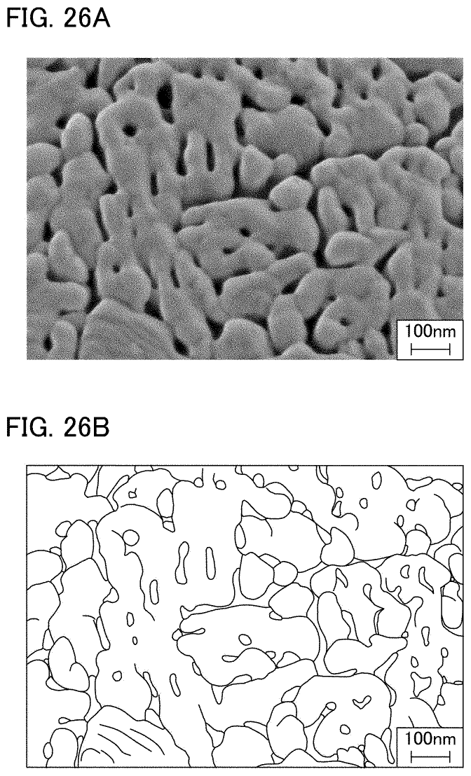

In the photocatalyst electrodes of Experimental Examples 5 and 6, the crystallite diameter calculated in XRD measurement is about 30 nm as shown in Table 1, whereas in the SEM images shown in FIGS. 23 and 25, a crystal aggregation having a primary particle diameter of about 2 μm to 6 μm is observed, and it was confirmed that the crystal aggregation is formed by aggregation of hematite-based crystal particles of about 100 nm to 200 nm as shown in FIGS. 24 and 26.

That is, in each of the meso-crystallized layers of Experimental Examples 1-1 and 2 to 6, there is a significant difference between the crystallite diameter measured by XRD and the particle diameter of the hematite-based crystal particle observed by SEM.

This may be because nanoparticles are fused at the time when the hematite-based crystal particles are sintered, and in the SEM image, crystalline nanoparticles turn into one crystal. In other words, it is suggested that the hematite layers of Experimental Examples 1-1 and 2 to 6 have higher crystallinity of hematite-based crystal particles and smaller bulk resistance of the hematite-based crystal particles as compared to the single crystal of Comparative Example 1.

In Experimental Example 1-2, the hematite-based crystal particles have a flat shape, and the hematite-based crystal particles are stacked while having overlapping portions in the thickness direction, as shown in FIGS. 13 and 16. The stacked hematite-based crystal particles come into surface contact with each one another in the thickness direction to form interparticle interfaces. Specific hematite-based crystal particles of Experimental Example 1-2 were partially fixed to other hematite-based crystal particles in a direction other than the thickness direction to form interparticle interfaces. In the specific hematite-based crystal particles of Experimental Example 1-2, holes extending inward are formed on the surface.

In Experimental Example 2, the hematite-based crystal particles have a substantially spherical shape or a substantially ellipsoidal shape, and have an outer surface forming a generally uniform curved surface, as shown in FIG. 17. In the hematite-based crystal particles of Experimental Example 2, the hematite-based crystal particles are stacked while having overlapping portions in the thickness direction, and the stacked hematite-based crystal particles come into surface contact with one another in the thickness direction to form interparticle interfaces.

Comparison between the shapes of the hematite-based crystal particles of Experimental Examples 1-2 and 2 shows that, as described above, the hematite-based crystal particles of Experimental Example 2 have a substantially spherical or substantially ellipsoidal shape, and have an outer surface forming a generally uniform curved surface, as shown in FIG. 17. On the other hand, the hematite-based crystal particles of Experimental Example 1-2 which are doped with titanium had a flat shape obtained by compressing the hematite-based crystal particles of Experimental Example 2 in the thickness direction, and the thickness is smaller as compared to the length and the width, as shown in FIGS. 13, 15A and 16. The hematite-based crystal particles of Experimental Example 1-2 which are doped with titanium have a primary particle diameter smaller than that of the hematite-based crystal particles of Experimental Example 2.

This indicates that in Experimental Example 1-1, doping with titanium distorted the crystal structure, so that the crystal has a distorted structure.

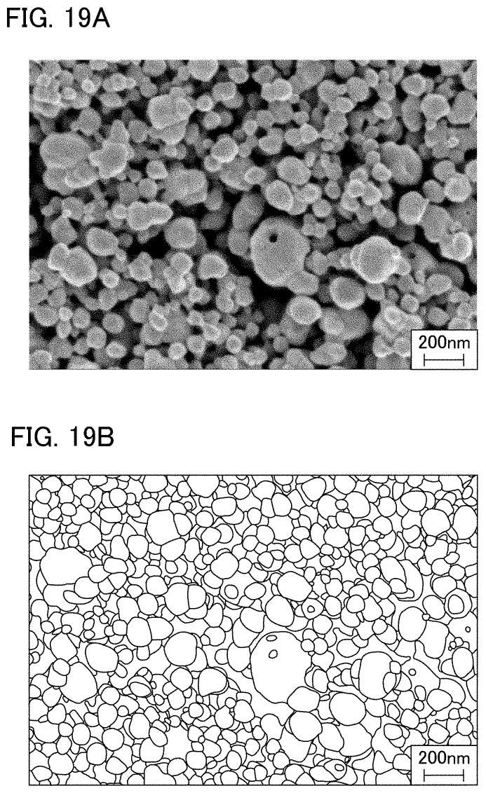

In the photocatalyst electrode of Experimental Example 3, the cross-section of the hematite-based crystal particle has a substantially circular shape as shown in FIG. 14, and the hematite-based crystal particle has a substantially spherical or substantially ellipsoidal outer shape, and has an outer surface forming a generally uniform curved surface, as shown in FIG. 19.

In the hematite-based crystal particles of Experimental Example 3, the hematite-based crystal particles are stacked while having overlapping portions in the thickness direction, and the stacked hematite-based crystal particles come into surface contact with one another in the thickness direction to form interparticle interfaces.

In the photocatalyst electrode of Experimental Example 3, a plurality of hematite-based crystal particles are preferentially fixed to one hematite-based crystal particle in the extending direction of the FTO substrate.

As shown in FIG. 20, the hematite-based crystal particles of Experimental Example 3 include particles in which a hole with a minimum inclusion circle having a diameter of about 40 nm is formed in the surface.

The photocatalyst electrode of Experimental Example 3 includes hematite-based crystal particles entering the recessed section on the surface of the FTO substrate and fixed to the FTO in the recessed section.

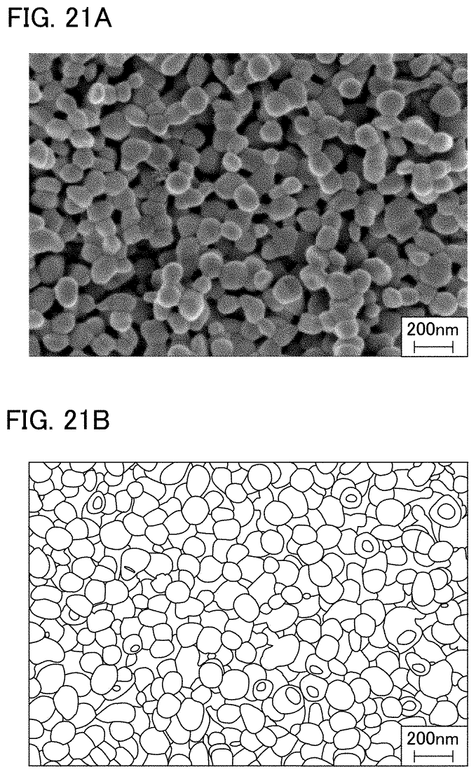

In the photocatalyst electrode of Experimental Example 4, the hematite-based crystal particles have a substantially spherical shape or a substantially ellipsoidal shape, and has an outer surface forming a generally uniform curved surface, as shown in FIGS. 21 and 22. In the hematite-based crystal particles of Experimental Example 4, the hematite-based crystal particles are stacked while having overlapping portions in the thickness direction, and the stacked hematite-based crystal particles come into surface contact with one another in the thickness direction to form interparticle interfaces.

In the photocatalyst electrode of Experimental Example 4, a plurality of hematite-based crystal particles are preferentially fixed to one hematite-based crystal particle in the extending direction of the FTO substrate.

Comparison between Experimental Examples 3 and 4 shows that in Experimental Example 3, the number of hematite-based crystal particles having a small particle diameter are larger as compared to Experimental Example 4, and some hematite-based crystal particles have a hole formed on the surface. In Experimental Example 4, the number of hematite-based crystal particles fix to one hematite-based crystal particle in plan view of the FTO substrate is larger as compared to Experimental Example 3.

In the photocatalyst electrode of Experimental Example 5, crystal aggregations are stacked as shown in FIG. 23. In the photocatalyst electrode of Experimental Example 5, a plurality of hematite-based crystal particles are regularly arranged and fixed to form a crystal aggregation, and the end portion has a curved shape.

In the crystal aggregation of Experimental Example 5, it is not possible to observe interfaces at which the hematite-based crystal particles are fixed, and the outer surfaces of the adjacent hematite-based crystal particles continue, as shown in FIG. 24.

As shown in FIG. 24, the crystal aggregation of Experimental Example 5 has a plurality of pores formed on the surface.

In Experimental Example 5, most of pores have a substantially circular or substantially elliptical shape, and are each individually formed. The diameter of the minimum inclusion circle of the pore is about 5 nm to 50 nm.

In the photocatalyst electrode of Experimental Example 6, crystal aggregations are stacked as shown in FIG. 25. In the photocatalyst electrode of Experimental Example 6, a plurality of hematite-based crystal particles are regularly arranged and fix to form a crystal aggregation, and the end portion has a curved shape.

In the crystal aggregation of Experimental Example 6, pores are formed between adjacent hematite-based crystal particles as shown in FIG. 26.

In Experimental Example 6, some of the pores have a substantially circular or substantially elliptical shape, and most of the pores are elongated holes or grooves extending along the interface between hematite-based crystal particles like cerebral sulcus, as shown in FIG. 26.

The width of the pore is about 2 nm to 50 nm.

Comparison between Experimental Examples 5 and 6 shows that in Experimental Example 6 where doping with titanium is performed, the depth of pores is larger and the size of the crystal aggregation and the size of the hematite-based crystal particles forming the crystal aggregation are smaller as compared to Experimental Example 5.

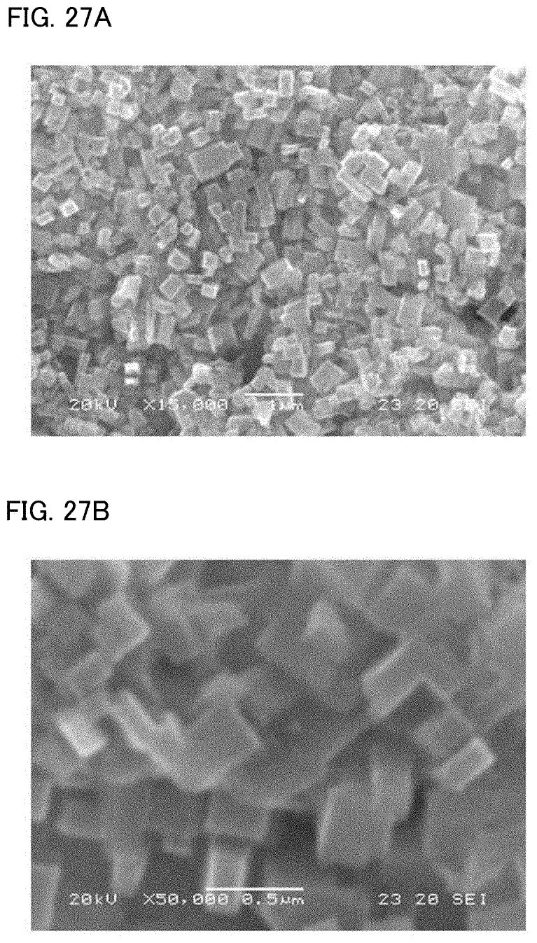

In the photocatalyst electrode of Comparative Example 3, rectangular parallelepiped or cubic particles are randomly stacked, and each particle is angular, as shown in FIG. 27.

(c) Results of Observation with Transmission Electron Microscope

In Experimental Example 1-1, it is confirmed that on the surface of the hematite-based crystal particle before and after burning, i.e. in both the hematite-based crystal particle (before sintering) and the hematite-based crystal particles (after sintering), cross stripes on the (104) plane are observed in a TEM image, and the crystalline nanoparticles are uniformly oriented in a SAED image, as shown in FIG. 28.

Further, in the EDX measurement, Fe, O, and Ti elements are detected in a state of being evenly distributed in one hematite-based crystal particle and on the surface of the hematite-based crystal particle, and the Ti concentration is 8.5%, as shown in FIG. 29. In the Fe and O mapping, a plurality of circular holes in which Fe and O are not detected are observed in part.

In Experimental Example 3, Fe, O, and Ti elements were detected in a state of being evenly distributed in one hematite-based crystal particle and on the surface of the hematite-based crystal particle in the EDX measurement, and a plurality of circular holes in which Fe and O were not detected were observed in part in Fe and O mapping, as in Experimental Example 1-1.

(Impedance Measurement)

A working electrode, a counter electrode and a reference electrode were immersed in a 1.0 M sodium hydroxide aqueous solution as an electrolyte at pH 13.6 to form an electrochemical cell, and AC impedance measurement was performed with the working electrode irradiated with simulated solar (AM 1.5G, 1000 W/m², 25° C.) using a solar simulator. The Nyquist plot obtained by the AC impedance measurement was fitted to evaluate the series resistance, the charge transfer resistance in the hematite layer, and the charge transfer resistance at the interface between the hematite layer and electrolyte (hereinafter, also referred to simply as interface resistance). Further, the donor density at 10 kHz was evaluated from the series capacitance C_{bulk} of the depletion layer/electric double layer at the interface between the hematite layer and electrolyte.

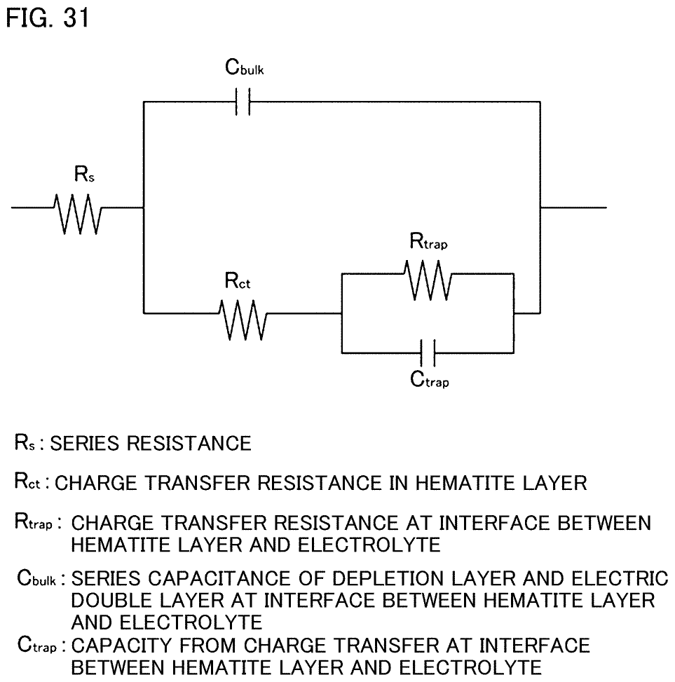

The photocatalyst electrode of each of Experimental Examples 1-1 and 2 to 4, and Comparative Example 1 was used as the working electrode, a platinum mesh was used as the counter electrode, and Ag/AgCl was used as the reference electrode. The equivalent circuit used for fitting is shown in FIG. 31.

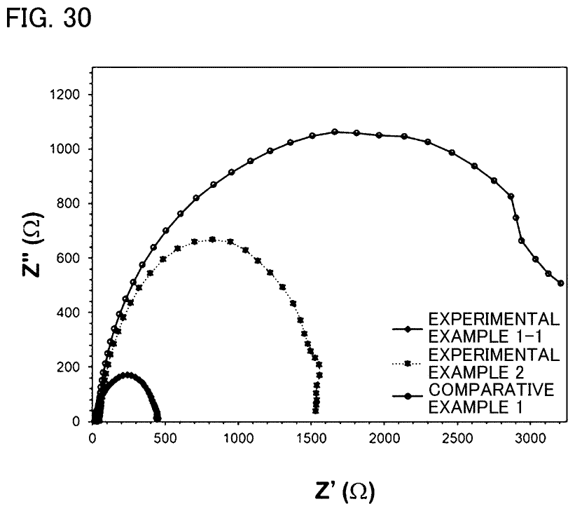

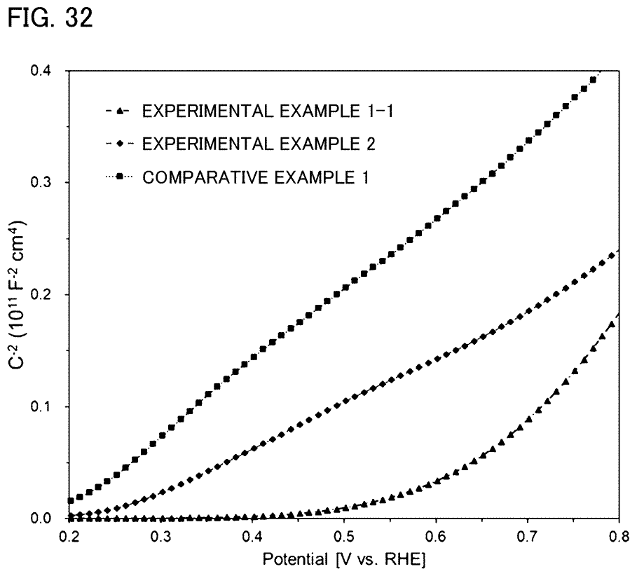

Nyquist plots for the photocatalyst electrodes of Experimental Examples 1-1 and 2, and Comparative Example 1 are shown in FIG. 30, and Mott-Schottky plots for the photocatalyst electrodes are shown in FIG. 32. Table 2 shows the respective resistances of the photocatalyst electrodes of Experimental Examples 1-1, 2 to 4, and Comparative Example 1, and the donor densities obtained from the slope of the Mott-Schottky plot.

TABLE 2

| | | | Charge Transfer | |
|---|---|---|---|---|
| | | | Resistance at | |
| | Series | Charge Transfer | Interface Between | |
| | Resis- | Resistance in | Hematite Layer | Donor |
| | tance | Hematite Layer | And Electrolyte | Density |
| | (Ω) | (Ω) | (Ω) | (cm⁻³) |
| Experimental | 21 | 180 | 233 | 2.0 × 10²⁰ |
| Example 1-1 | | | | |
| Experimental | 48 | 282 | 1180 | 3.2 × 10¹⁹ |
| Example 2 | | | | |
| Experimental | 11 | 4.3 | 253 | 4.0 × 10²¹ |
| Example 3 | | | | |
| Experimental | 66 | 210 | 138 | 1.2 × 10²¹ |
| Example 4 | | | | |
| Comparative | 49 | 1346 | 1639 | 1.9 × 10¹⁹ |
| Example 1 | | | | |

It is apparent from Table 2 that in the mesocrystals of Experimental Examples 1-1 and 2 to 4, resistance values for all of the series resistance, the charge transfer resistance in the hematite layer and the resistance at the interface between the hematite layer and the electrolyte are smaller as compared with the single crystal of Comparative Example 1, and in particular, the charge transfer resistance in the hematite layer and the resistance at the interface between the hematite layer and the electrolyte are small.

In Experimental Example 2, the charge transfer resistance in the hematite layer is 21% or less of that in Comparative Example 1, and the resistance at the interface between the hematite layer and the electrolyte is 72% or less of that in Comparative Example 1.

In Experimental Example 4, the charge transfer resistance in the hematite layer is 16% or less of that in Comparative Example 1, and the resistance at the interface between the hematite layer and the electrolyte was 9% or less of that in Comparative Example 1.

The donor density in Experimental Example 2 is 1.68 times the donor density in Comparative Example 1, and the donor density in Experimental Example 4 is 63 times the donor density in Comparative Example 1.

Thus, it was found that in photocatalyst electrodes formed from the same hematite, it is possible to reduce the charge transfer resistance in the hematite layer and the resistance at the interface between the hematite layer and the electrolyte, and to improve the donor density by mesocrystallization.

This may be because mesocrystallization regulates the arrangement of the hematite-based crystal particles, improves the charge transfer characteristics, and increases the fixing area between the hematite-based crystal particles to improve crystallinity, leading to a decrease in particle boundary resistance.

In Experimental Example 1-1 where doping with titanium is performed, resistance values for all of the series resistance, the charge transfer resistance in the hematite layer, and the resistance at the interface between the hematite layer and the electrolyte are smaller as compared with the Experimental Example 2 where doping with titanium is not performed.

In particular, in Experimental Example 1-1, the charge transfer resistance in the hematite layer is 64% or less of the charge transfer resistance in the hematite layer in Experimental Example 2, and the resistance at the interface between the hematite layer and the electrolyte is 20% or less of the resistance at the interface between the hematite layer and the electrolyte in Experimental Example 2.

In Experimental Example 3 where doping with titanium is performed, resistance values for the series resistance and the charge transfer resistance in the hematite layer are smaller as compared with the Experimental Example 4 where doping with titanium is not performed.

In particular, in Experimental Example 3, the charge transfer resistance in the hematite layer is 2% or less of the charge transfer resistance in the hematite layer in Experimental Example 4.

The donor density in Experimental Example 1-1 was 6.25 times the donor density in Experimental Example 2, and the donor density in Experimental Example 3 was 3.33 times the donor density in Experimental Example 4.

These results show that by doping with titanium, the donor density is further increased, and the charge transfer characteristics in the hematite layer are improved.

(Electrochemical Evaluation)

As in the AC impedance measurement, a working electrode, a counter electrode and a reference electrode were immersed in a 1.0 M sodium hydroxide aqueous solution at pH 13.6, the current value for each potential was measured with the working electrode irradiated with simulated solar (AM 1.5G, 1000 W/m², 25° C.) using a solar simulator, and the photocurrent density for each potential was calculated. The photocatalyst electrode of each of Experimental Examples 1-1 and 1-2, and 2 to 8, and Comparative Examples 1 to 3 was used as the working electrode, a platinum mesh was used as the counter electrode, and Ag/AgCl was used as the reference electrode. After the measurement of the current value, the photocatalyst electrode was taken out from the solution, and whether or not the hematite layer was peeled from the FTO substrate was examined.

For electrochemical evaluation, ALS600E manufactured by BAS Inc. was used as an electrochemical analyzer, CT-10 manufactured by JASCO Corporation was used as a spectroscope, and MAX-303 (300 W xenon light source) manufactured by Asahi Spectra Co., Ltd. was used as a light source.

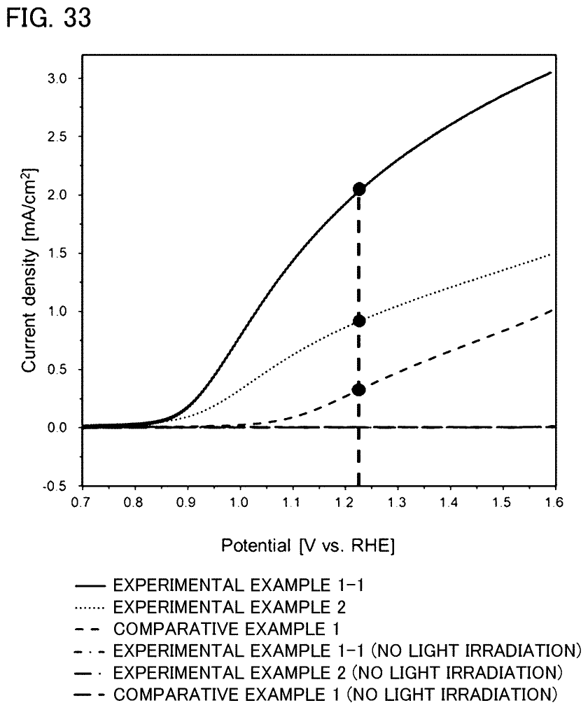

The results of the electrochemical evaluation are shown in FIGS. 33 to 36 (photocurrent density for each potential) and Table 3. The voltage is based on a reversible hydrogen electrode (RHE).

TABLE 3

| | Rising | Photocurrent |
|---|---|---|
| | Potential | Density at 1.23 V |
| | (V) | (mAcm⁻²) |
| Experimental | 0.80 | 2.06 |
| Example 1-1 | | |
| Experimental | 0.81 | 2.51 |
| Example 1-2 | | |
| Experimental | 0.83 | 0.93 |
| Example 2 | | |
| Experimental | 0.81 | 4.30 |
| Example 3 | | |
| Experimental | 0.81 | 1.65 |
| Example 4 | | |
| Experimental | 0.70 | 0.72 |
| Example 5 | | |
| Experimental | <0.70 | 1.81 |
| Example 6 | | |
| Experimental | <0.70 | 3.81 |
| Example 7 | | |
| Experimental | <0.70 | 5.10 |
| Example 8 | | |
| Comparative | 1.01 | 0.34 |
| Example 1 | | |
| Comparative | 0.75 | 0.24 |
| Example 2 | | |
| Comparative | — | 0.03 |
| Example 3 | | |

In photocatalyst electrodes of Experimental Examples 1-1, 1-2 and 2 to 8, and Comparative Examples 1 and 2, the hematite-based crystal particles were not peeled even after photocurrent measurement, whereas in the photocatalyst electrode of Comparative Example 3, the hematite-based crystal particles were peeled after photocurrent measurement.

In Experimental Examples 1-1, 1-2, and 2 to 8, and Comparative Examples 1 and 2, a photocurrent density was not obtained when the photocatalyst electrode was not irradiated with light, and a photocurrent density was obtained when the photocatalyst electrode was irradiated with light, as shown in FIGS. 33 to 36. On the other hand, it was found that in Comparative Example 3, the photocurrent density was hardly obtained when the photocatalyst electrode was not irradiated with light and when the photocatalyst electrode was irradiated with light, and thus the photocatalyst electrode did not function as a photocatalyst.

This shows that when in-process particles are formed by a solvothermal method, and the in-process particles are burned, the photocatalyst electrode functions as a photocatalyst and peeling from the FTO substrate hardly occurs in Experimental Examples 1 to 8 and Comparative Examples 1 and 2.

In Experimental Example 2, the rising potential is a lower potential that is about 0.18 V, and the photocurrent density at 1.23 V vs. RHE is 2.74 times larger as compared to the single crystal of Comparative Example 1, as shown in Table 3 and FIG. 33.

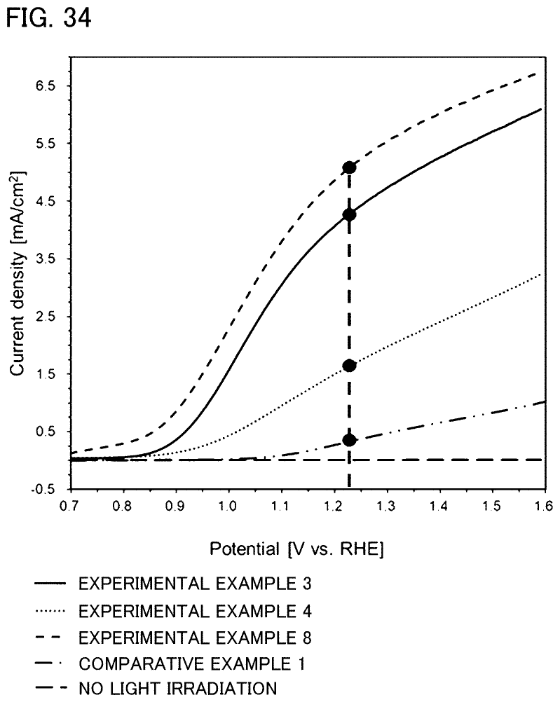

In Experimental Example 4, the rising potential is a lower potential that is 0.20 V, and the photocurrent density at 1.23 V vs. RHE is 14.85 times larger as compared to the single crystal of Comparative Example 1, as shown in Table 3 and FIG. 34.

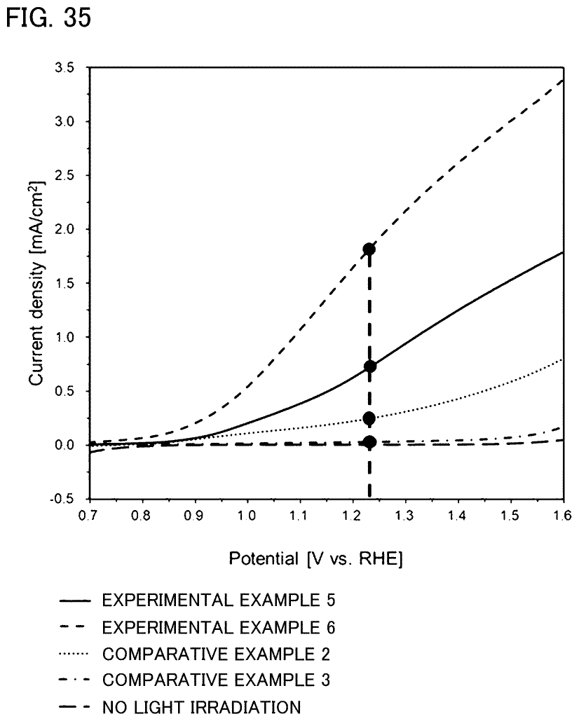

In Experimental Example 5, the rising potential is a lower potential that is 0.31 V, and the photocurrent density at 1.23 V vs. RHE is 2.12 times larger as compared to the single crystal of Comparative Example 1, as shown in Table 3 and FIG. 35.

Thus, it was found that in photocatalyst electrodes formed from the same hematite, the rising potential and the photocurrent density are increased and catalytic activity is improved by mesocrystallization.

This may be because mesocrystallization regulates the arrangement of the nanoparticles to reduce the bulk resistance in the hematite-based crystal particles, and increases the contact area between the hematite-based crystal particles, so that the charge transfer resistance in the hematite layer decreases.

In Comparative Example 2, the rising potential is a lower potential that is 0.26 V, and although mesocrystallization is performed, the photocurrent density at 1.23 V vs. RHE is 0.71 times larger as compared to the single crystal of Comparative Example 1, as shown in Table 3 and FIG. 35. This may be because in Comparative Example 2, the heating time is insufficient, and mesocrystals of good quality are not formed as in-process particles.

In the single crystal of Comparative Example 1, the hematite-based crystal particles are nanosized particles, and are randomly oriented. Therefore, it is considered that holes are recombined with electrons in the hematite-based crystal particles, so that a photocurrent is not effectively extracted, and thus the characteristics as a photocatalyst are not sufficient.

In Experimental Example 1-1 where doping with titanium is performed, the rising potential is a slightly lower potential and the photocurrent density at 1.23 V vs. RHE was 2.22 times larger as compared to that in Experimental Example 2 where doping with titanium is not performed, as shown in Table 3 and FIG. 33.

In Experimental Example 3 where doping with titanium is performed, the photocurrent density at 1.23 V vs. RHE is 2.61 times larger as compared to that in Experimental Example 4 where doping with titanium is not performed, as shown in Table 3 and FIG. 34.

In Experimental Example 6 where doping with titanium is performed, the rising potential is a lower potential and the photocurrent density at 1.23 V vs. RHE is 2.51 times larger as compared to that in Experimental Example 5 where doping with titanium is not performed, as shown in Table 3 and FIG. 35.

Thus, it was found that by performing doping with titanium, the rising potential and the photocurrent density are increased and catalytic activity is improved.

This may be because by performing doping with titanium, the electronic structure and the crystal structure are changed to increase the number of conductive paths, so that the total resistance decreases, leading to improvement of catalytic activity.

In Experimental Examples 1-1 and 3, one factor may be that gaps are formed in the hematite-based crystal particles, and therefore water penetrates the gaps in the particles or light passes through the gaps to be scattered, leading to an increase in reaction area.

In Experimental Example 6, one factor may be that the depth of the pores increases, and therefore water entered the pores, leading to an increase in reaction area with water on the surfaces of the hematite-based crystal particles.

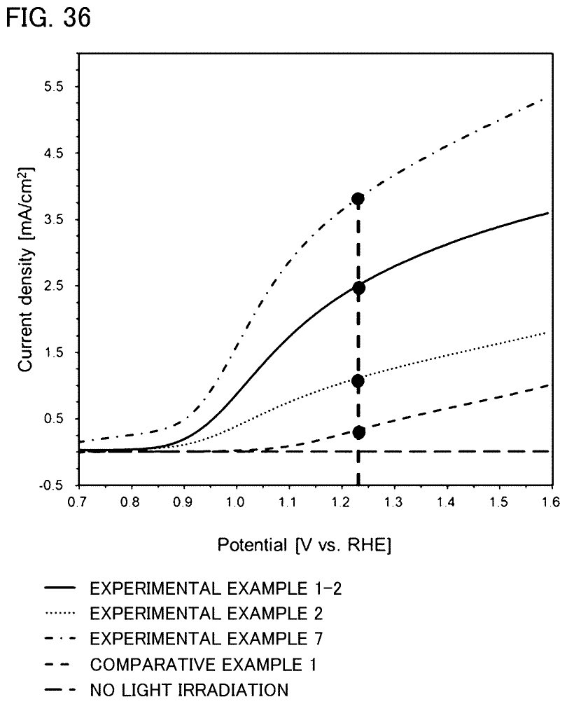

In Experimental Example 7 where a promoter is carried on, the rising potential is a lower potential and the photocurrent density at 1.23 V vs. RHE is 1.52 times larger as compared to that in Experimental Example 1-2 where a promoter is not carried on, as shown in Table 3 and FIG. 36.

In Experimental Example 8 where a promoter is carried on, the rising potential is a lower potential and the photocurrent density at 1.23 V vs. RHE is 1.19 times larger as compared to that in Experimental Example 3 where a promoter is not carried on, as shown in Table 3 and FIG. 34.

Thus, it was found that by carrying a promoter, the rising potential and the photocurrent density are increased and catalytic activity is improved.

This may be because conductivity is improved by the promoter, and the carrier is transferred to the promotor and served as a reaction point.

In Experimental Example 3, as shown in Table 3, the photocurrent density at 1.23 V vs. RHE is 1.71 times larger as compared to that in Experimental Example 1-2 where the crystal is oriented along the (104) plane.

In Experimental Example 4, as shown in Table 3, the photocurrent density at 1.23 V vs. RHE is 1.77 times larger as compared to that in Experimental Example 2 where the crystal is oriented along the (104) plane.

This may be because the ratio of the (110) plane to the (104) plane increases, so that there are a large number of interface oxygen defects, leading to improvement of conductivity.

In Experimental Example 5 where water is used as a solvent for forming the in-process particles, the rising potential is a lower potential as compared to each of Experimental Examples 1-1 and 4 where alcohol is used as a solvent for forming the in-process particles.

This may be because in Experimental Example 5, hematite-based crystal particles are aggregated to form a crystal aggregation, so that the primary particle diameter is large as a whole, and high crystallinity is obtained, leading to a decrease in the number of defects on the surface.

Normally, the size of an area where light passes through the hematite layer is several hundreds of nm, and it was considered that little light is applied at a position 1 μm or more away from the light irradiation side because of dense packing.

However, in Experimental Example 1-2 where the average thickness of the hematite layer is 1.6 the photocurrent density at 1.23 V vs. RHE was 1.22 times larger as compared to that in Experimental Example 1-1 where the average thickness is 1.2 That is, catalytic activity is exhibited even at a part where light is not directly applied.

This may be because the number of regions where charge is able to diffuse is increased, so that recombination is suppressed. One factor thereof may be that the particle boundary resistance of the hematite layer is small, a cavity is formed in the hematite-based crystal particle, and the cavity is filled with water, so that catalyst reaction occurs in the cavity, light passes the inside of the cavity while scattering, and reaches a deeper position, etc.

Thus, by performing the mesocrystallization, the hematite-based crystal particles are more regularly oriented as compared to the single-crystal hematite layer, so that the bondability between the substrate and the hematite crystal particles is improved. It was found that as a result, the series resistance, the charge transfer resistance and the resistance at the interface in the hematite layer are reduced to improve catalytic activity.

It was found that by performing doping with titanium, the rising potential and the photocurrent density are increased and catalytic activity is improved.

It was found that by carrying a promoter, the rising potential and the photocurrent density are increased and catalytic activity is improved.

It was found that by increasing the ratio of the (110) plane to the (104) plane, conductivity is improved, leading to improvement of catalytic activity.

It was found that when the photocatalyst electrode is produced by hydrothermal synthesis using water as a solvent, crystallinity is improved, and the rising potential is shifted to a lower potential.

### EXPLANATION OF REFERENCE SIGNS

1, 100, 200, 300, 400, 500: Photocatalyst electrode
2: Substrate
3, 103, 203, 303, 403, 503: Hematite layer
5, 105, 205, 305, 405, 505: Hematite-based crystal particle
6: Gap
10: Transparent substrate
11: Transparent conductive layer
23, 223: Cavity
211: Recessed section
225: Hole
406, 506: Crystal aggregation
409, 509: Pore

1-21. (canceled)

22. A photocatalyst electrode comprising:
a substrate; and
a plurality of hematite-based crystal particles stacked on a first main surface of the substrate,
wherein the plurality of hematite-based crystal particles have a spherical shape or a shape with rounded corners and form a hematite layer covering the first main surface of the substrate,
wherein the plurality of hematite-based crystal particles include a first and a second hematite-based crystal particles, the first and the second hematite-based crystal particles adjacently located,
wherein a part of an outer surface of the first hematite-based crystal particle is fixed to an outer surface of the second hematite-based crystal particle, and
wherein the first hematite-based crystal particle has a cavity inside the particle.

23. The photocatalyst electrode according to claim 22, wherein the first hematite-based crystal particle and the second hematite-based crystal particle are fixed to each other in a direction intersecting a direction orthogonal to the first main surface.

24. The photocatalyst electrode according to claim 22,
wherein the plurality of hematite-based crystal particles include a third hematite-based crystal particle adjacent to the first hematite-based crystal particle, and
wherein the outer surface of the first hematite-based crystal particle is fixed to a part of an outer surface of the third hematite-based crystal particle at a part different from the part where the first hematite-based crystal particle is fixed to the second hematite-based crystal particle.

25. The photocatalyst electrode according to claim 22, wherein the first hematite-based crystal particle has two or more cavities inside the particle.

26. The photocatalyst electrode according to claim 22, wherein the cavity communicates outside.

27. The photocatalyst electrode according to claim 22, wherein in the hematite layer, four or more cavities provided in the hematite-based crystal particles exist in an area of 500 nm square on a cross-section orthogonal to the first main surface of the substrate.

28. The photocatalyst electrode according to claim 22, wherein the hematite layer has a gap extending from the outer surface toward the substrate through spaces between the hematite-based crystal particles.

29. The photocatalyst electrode according to claim 22,
wherein the plurality of hematite-based crystal particles constitute a crystal aggregation, and
wherein the crystal aggregation has a hole formed at an interface between adjacent hematite-based crystal particles.

30. The photocatalyst electrode according to claim 22, wherein the hematite-based crystal particles are doped with titanium.

31. The photocatalyst electrode according to claim 22, wherein the hematite layer has an average thickness of 1.0 μm or more.

32. The photocatalyst electrode according to claim 22,
wherein there is a difference between a number average particle diameter of the hematite-based crystal particles observed with a scanning electron microscope and a crystallite diameter calculated from the Scherrer formula on the basis of half width of a diffraction peak in X-ray diffraction measurement, and
wherein a ratio of the number average particle diameter of the hematite-based crystal particles to the crystallite diameter is 3 or more and 20 or less.

33. The photocatalyst electrode according to claim 22,
wherein the substrate is a transparent conductive substrate having a transparent conductive layer laminated on a transparent substrate,
wherein the transparent conductive layer has irregularities on a surface thereof, and
wherein the plurality of hematite-based crystal particles include a hematite-based crystal particle that has a particle diameter smaller than a depth of a recessed section of the transparent conductive layer and that is fixed to the transparent conductive layer in the recessed section.

34. The photocatalyst electrode according to claim 22, wherein when the photocatalyst electrode is immersed in water together with a counter electrode, the water is oxidized with irradiation of light.

35. A photocatalyst electrode comprising:
a substrate; and
a plurality of hematite-based crystal particles stacked on a first main surface of the substrate,
wherein the plurality of hematite-based crystal particles form a hematite layer covering the first main surface of the substrate,
wherein the hematite-based crystal particles each include a plurality of crystalline particles aggregated therein and fixing together in a planar shape,
wherein there is a difference between a number average particle diameter of the hematite-based crystal particles observed with a scanning electron microscope and a crystallite diameter calculated from the Scherrer formula on the basis of half width of a diffraction peak in X-ray diffraction measurement,
wherein a number average particle diameter of the hematite-based crystal particles is 200 nm or less, and
wherein the crystallite diameter is 25 nm or less.

36. A method for producing a photocatalyst electrode, the photocatalyst electrode comprising:
a substrate; and
a plurality of hematite-based crystal particles stacked on a first main surface of the substrate,
the method comprising:
an in-process particle forming step of heating a raw material solution to form in-process particles, the raw material solution including a raw material solvent and a hematite raw material dispersed therein, the in-process particle forming step including heating the raw material solution in a closed vessel for more than 12 hours at a temperature equal to or higher than a boiling point of the raw material solvent;
a coating step of dispersing the in-process particles in a dispersion solvent to form a dispersion solution and coating the substrate with the dispersion solution; and
a burning step of burning the in-process particles with which the substrate is coated in the coating step.

37. A method for producing a photocatalyst electrode, the photocatalyst electrode comprising:
a substrate; and
a plurality of hematite-based crystal particles stacked on a first main surface of the substrate,
the method comprising:
an in-process particle forming step of heating a raw material solution to form in-process particles, the raw material solution including a raw material solvent and a hematite raw material dispersed therein, the in-process particle forming step including heating the raw material solution in a closed vessel for more than 12 hours at a temperature equal to or higher than a boiling point of the raw material solvent; and
a burning step of burning the in-process particles,
wherein the in-process particle forming step includes:
introducing the raw material solution into the closed vessel; and
heating the substrate in the closed vessel in a state that the substrate is partially or totally immersed in the raw material solution, and
wherein the burning step includes:
taking out the substrate from the raw material solution; and
burning the substrate outside the closed vessel.

38. The method according to claim 36, wherein the hematite raw material includes a titanium-containing compound.

39. The method according to claim 36, wherein the raw material solvent is alcohol.

40. The method according to claim 37, wherein the raw material solvent is water.
